(19) United States
(12) Patent Application Publication
(10) Pub. No.: US 2013/0334349 A1
(43) Pub. Date: Dec. 19, 2013

(54) FOOD PROCESSING AND PREPARATION APPARATUS

(71) Applicant: Michelle Lisbeth Carden, Leederville (AU)

(72) Inventor: Michelle Lisbeth Carden, Leederville (AU)

(73) Assignee: MLC CORPORATION PTY LTD, North Ringwood (AU)

(21) Appl. No.: 13/818,633

(22) PCT Filed: Aug. 30, 2011
(86) PCT No.: PCT/US11/49740

§ 371 Date: Jul. 17, 2013

Related U.S. Application Data
(60) Provisional application No. 61/379,122, filed on Sep. 1, 2010.
(60) Provisional application No. 61/379,142, filed on Sep. 1, 2010.
(60) Provisional application No. 61/379,136, filed on Sep. 1, 2010.
(60) Provisional application No. 61/379,430, filed on Sep. 2, 2010.
(60) Provisional application No. 61/379,456, filed on Sep. 2, 2010.
(60) Provisional application No. 61/379,427, filed on Sep. 2, 2010.

(51) Int. Cl. A47J 43/07

(52) U.S. Cl. CPC A47J 43/07
USPC 241/68; 241/101.2; 241/101.3

(57) ABSTRACT

A food processing and preparation apparatus (10, 100) includes a housing (102) having a footing portion (104) and an arm section (106, 108) that together delimit a housing cavity (110), a vessel (200) defining a food chamber (204) and positionable in the housing cavity, and a blade (502) mounted for movement within the food chamber (204) of the vessel. Also, the food processing and preparation apparatus (10, 100) includes a blade movement system (500) including a motor (504) mounted within the housing (102) and an intermediary element (508) for transferring motive power from the motor (504) to the blade (502) to thereby effect movement of the blade within the food chamber (204) of the vessel (200) and a heating system (50, 700).

### TECHNICAL FIELD

The present invention relates broadly to countertop kitchen appliances apparatus and, more particularly, to a countertop food processing and preparation apparatus.

While kitchens have long been a traditional room in houses and other residences, the era of powered kitchen appliances has only been in more recent times and principally in the last century. A decline in the employment of servants—and therewith a corresponding increase in households without servants—further highlighted the desirability of developing suitable kitchen appliances to assist in food processing and preparation. Additionally, the advent of electricity greatly advanced the technology of kitchen appliances. Large kitchen appliances such as the dishwasher, oven or stove, microwave oven, and refrigerator have become widely available.

Small kitchen appliances also have come to the forefront including blenders and food processors that rapidly speed up mixing and chopping food. Such labor-saving devices typically put demands on electrical usage and availability. Another cost of prolific small appliance usage has been increased crowding of available countertop space in kitchens.

As small kitchen appliances develop further, it is desirable to have a small, countertop kitchen food processing and preparation apparatus that can process and prepare foods in such a manner such that the completed food, such as a cooked meal, is appealing and nutritious.

### SUMMARY OF THE INVENTION

It is accordingly an object of the present invention to provide a countertop food processing and preparation apparatus that can perform several food processing and preparation operations and can carry out preprogrammed recipes such that a user may provide raw ingredients and the food processing and preparation appliance or apparatus can produce a substantially complete meal or dish, or a ready to cook meal or dish.

To that end, a food processing and preparation apparatus includes a housing having a footing portion and an arm section, the arm section including at least two upwardly projecting arms spaced from one another and joined to the footing portion at a trunk transition location, with the footing portion and the arm section together delimiting a housing cavity, a vessel defining a food chamber and being positionable in the housing cavity, and a blade mounted for movement within the food chamber of the vessel. Also, the food processing and preparation apparatus includes a blade movement system including a motor mounted within the housing and an intermediary element for transferring motive power from the motor to the blade to thereby effect movement of the blade within the food chamber of the vessel and a heating system. The heating system is selectively disposable in contact with at least one of the vessel or contents in the vessel when the vessel is positioned within the housing cavity and the heating system being operable to selectively resist a decrease of the temperature of contents that have been deposited in the vessel. The food processing and preparation apparatus also includes a cooling system, the cooling system being selectively disposable in contact with at least one of the vessel or contents in the vessel when the vessel is positioned within the housing cavity and the cooling system being operable to selectively resist an increase in the temperature of contents that have been deposited in the vessel. Further included is a control system defining a user interface and including controls for use in operating the apparatus, the controls being in operational communication with the stirring system, the heating system and the cooling system.

The heating system advantageously permits the vessel to be configured as a stable, high quality retainer for food items with a heating configuration that is reliably connected with a heating source via the simple action of a user placing the vessel on a platform.

The cooling system, in one aspect thereof, is selectively disposable in contact with at least one of the vessel or contents in the vessel when the vessel is positioned within the housing cavity and the cooling system being operable to selectively resist an increase in the temperature of contents that have been deposited in the vessel.

According to further features of the cooling system, the cooling system includes a Peltier element and a heat sink in operational communication therewith. The heat sink is movable into and out of contact with a vessel positioned within the cavity.

The food processing and preparation apparatus can also include a weighing system for selective weighing of a vessel disposed within the cavity and any contents of the vessel; and a control system defining a user interface and including controls for use in operating the apparatus, the controls being in operational communication with the stirring system, the heating system and the weighing system.

Preferably, the weighing system includes at least two support members for the housing and any vessel disposed within the cavity with the supports being bendable under the weight of the housing, vessel and vessel contents, the weighing system further including at least one strain gauge mounted to at least one of the at least two support members to measure the strain under bending of the support member, the strain gauge being in operational communication with the control system.

### BRIEF DESCRIPTION OF THE DRAWINGS

The features of the invention, and its technical advantages, can be seen from the following description of the preferred embodiments together with the claims and the accompanying drawings, in which:

FIG. 1 is a front view of a food processing and preparation apparatus according to one preferred embodiment of the present invention;

FIG. 2 is a left side view of the processing and preparation apparatus illustrated in FIG. 1;

FIG. 3 is a rear view of the processing and preparation apparatus illustrated in FIG. 1;

FIG. 4 is a front perspective view of the processing and preparation apparatus illustrated in FIG. 1;

FIG. 5 is a rear perspective view of the processing and preparation apparatus illustrated in FIG. 1;

FIG. 6 is a top plan view of the processing and preparation apparatus illustrated in FIG. 1 with the lid removed;

FIG. 7 is a bottom view of the processing and preparation apparatus illustrated in FIG. 1;

FIG. 8 is a front view of the processing and preparation apparatus illustrated in FIG. 1 with the vessel removed;

FIG. 9 is a rear view of the food processing and preparation apparatus illustrated in FIG. 8;

FIG. 10 is a front perspective view of the food processing and preparation apparatus illustrated in FIG. 8;

FIG. 11 is a rear perspective view of the food processing and preparation apparatus illustrated in FIG. 8;

FIG. 12 is an exploded view of the food processing and preparation apparatus illustrated in FIG. 1;

FIG. 13 is an exploded view of the mixing assembly of the food processing and preparation apparatus illustrated in FIG. 1;

FIG. 14 is a perspective view of a cooling device of the food processing and preparation apparatus illustrated in FIG. 1;

FIG. 15 is a rear perspective view of the cooling device of the food processing and preparation apparatus illustrated in FIG. 1;

FIG. 16 is a perspective view of the food processing and preparation apparatus illustrated in FIG. 1 with a panel removed to reveal the cooler location;

FIG. 17 is an exploded view of the heating apparatus of the food processing and preparation apparatus illustrated in FIG. 1;

FIG. 18 is a top plan view of the heating apparatus of the food processing and preparation apparatus illustrated in FIG. 1;

FIG. 19 is a perspective view of the food processing and preparation apparatus illustrated in FIG. 1 showing the location of the heating apparatus;

FIG. 20 is an exploded view of the weighing system of the food processing and preparation apparatus illustrated in FIG. 1;

FIG. 21 is a side view of the weighing system of the food processing and preparation apparatus illustrated in FIG. 1;

FIG. 22 is a top plan view of the weighing system seen internally within the food processing and preparation apparatus illustrated in FIG. 1;

FIG. 23 is an exploded view of the juicer attachment of the food processing and preparation apparatus illustrated in FIG. 1;

FIG. 24 is a perspective view of the food preparation and process apparatus illustrated in FIG. 1 with the juicer attached;

FIG. 25 is a side view of the steamer arrangement of the food processing and preparation apparatus illustrated in FIG. 1;

FIG. 26 is a top plan view of the steamer arrangement of the food processing and preparation apparatus illustrated in FIG. 1;

FIG. 27 is a side cut-away view of the steamer arrangement taken along lines XXVII-XXVII in FIG. 26;

FIG. 28 is an exploded view of the steamer apparatus of the food processing and preparation apparatus illustrated in FIG. 1;

FIG. 29 is a perspective view of the food processing and preparation apparatus illustrated in FIG. 1 having the steamer arrangement attached;

FIG. 30 is a side view of a specialty spatula for use with the food processing and preparation apparatus illustrated in FIG. 1;

FIG. 31 is a perspective view of the spatula illustrated in the FIG. 30;

FIG. 32 is an exploded view of the spatula in use with the vessel according to the present invention;

FIG. 33 is a front view of a food processing and preparation apparatus of the present invention;

FIG. 34 is a sectional side elevational view of the vessel and another version of a heating system of the food processing and preparation apparatus illustrated in FIG. 1;

FIG. 35 is an exploded view of one portion of the another version of a heating system of the food processing and preparation apparatus illustrated in FIG. 34; and

FIG. 36 is an exploded view of the vessel and the another version of a heating system of the food processing and preparation apparatus illustrated in FIG. 34.

### DETAILED DESCRIPTION OF PREFERRED EMBODIMENTS

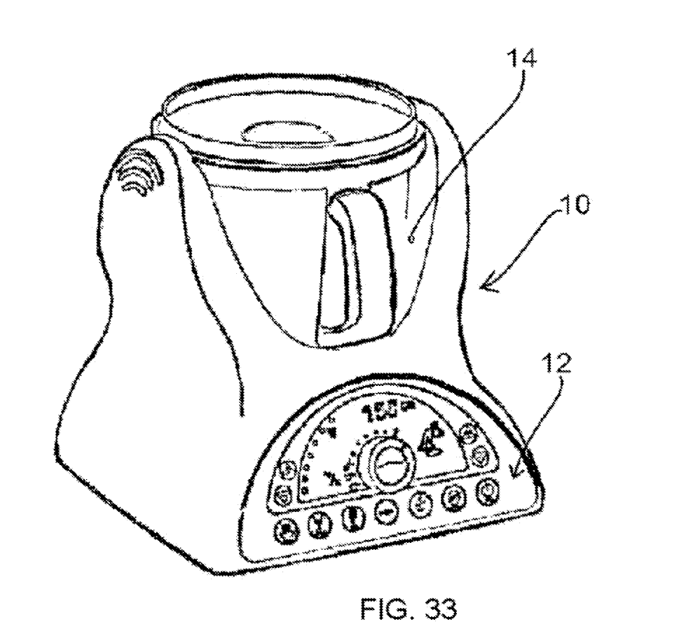

As seen in FIG. 33, the present invention provides a countertop food processing and preparation apparatus 10 that can perform several food processing and preparation operations and can carry out preprogrammed recipes such that a user may provide raw ingredients and the food processing and preparation appliance or apparatus can create a high quality food item ready for a further preparation step such as baking or being formed into a table ready food item or can create a substantially complete meal or dish. The countertop food processing and preparation apparatus 10 is durable and has a pleasing aesthetic appearance. Additionally, the countertop food processing and preparation apparatus 10 has an intuitive panel interface 12 that conveniently guides a user through the process of selecting the desired food preparation steps that will be executed by the countertop food processing and preparation apparatus 10. The food ingredients are placed into a pouring pitcher 14 that safely and hygienically retains the food ingredients during their preparation and, as well, that facilitates the dispensing of the prepared food products. The following disclosure will exemplarily illustrate several configurations of the food processing and preparation apparatus of the present invention, whereupon the range and utility of the food processing and preparation apparatus can be readily understood.

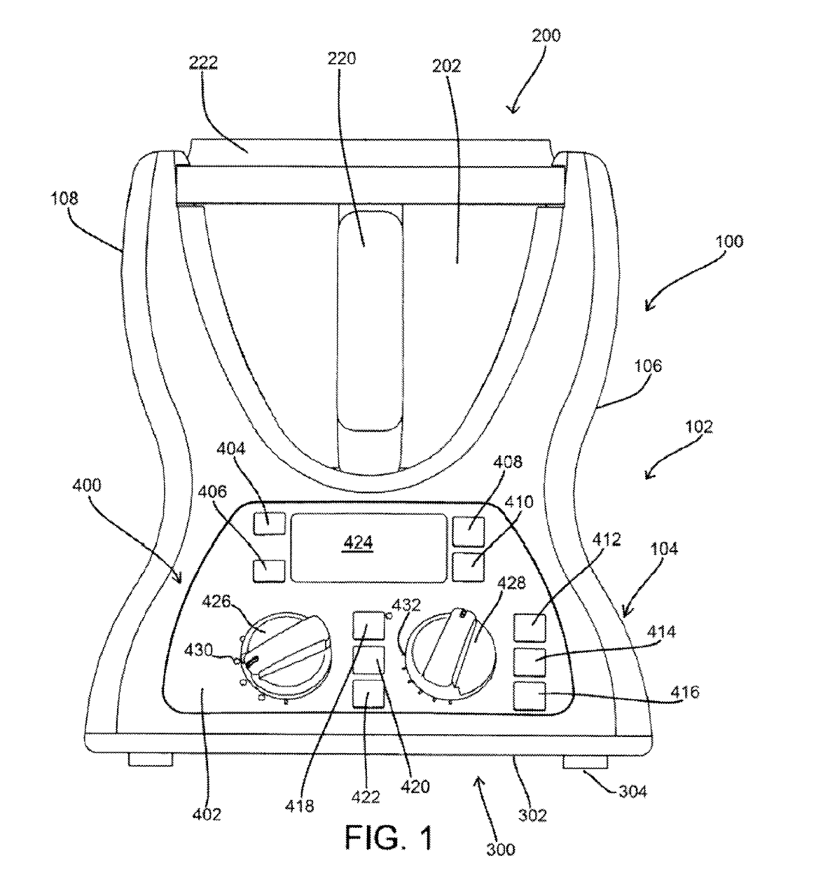

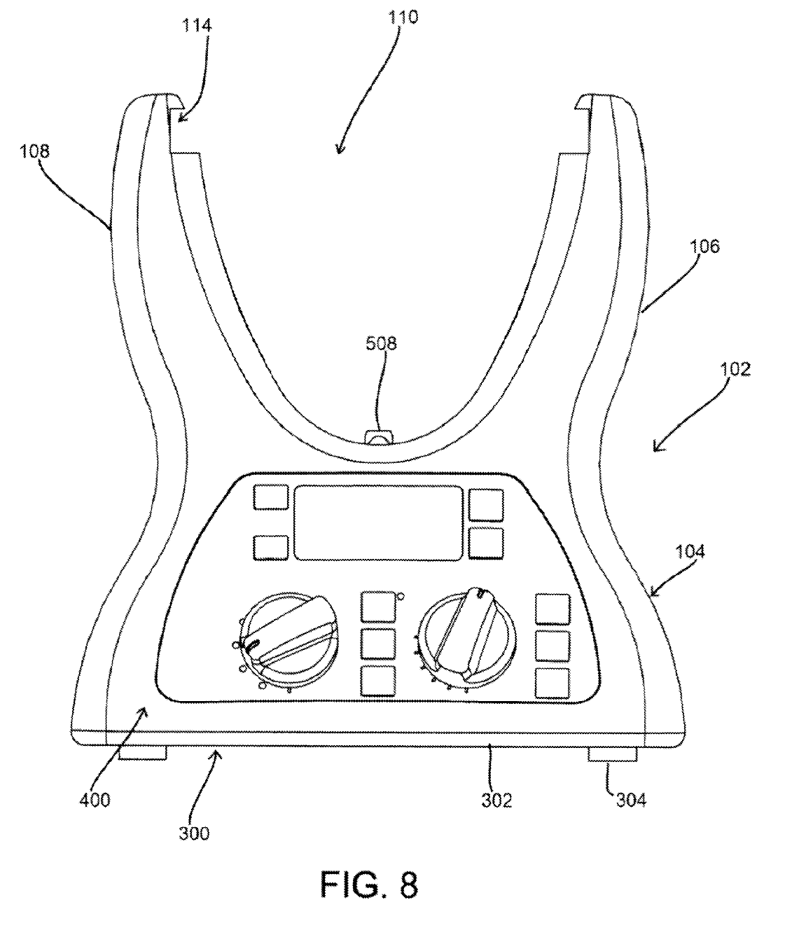

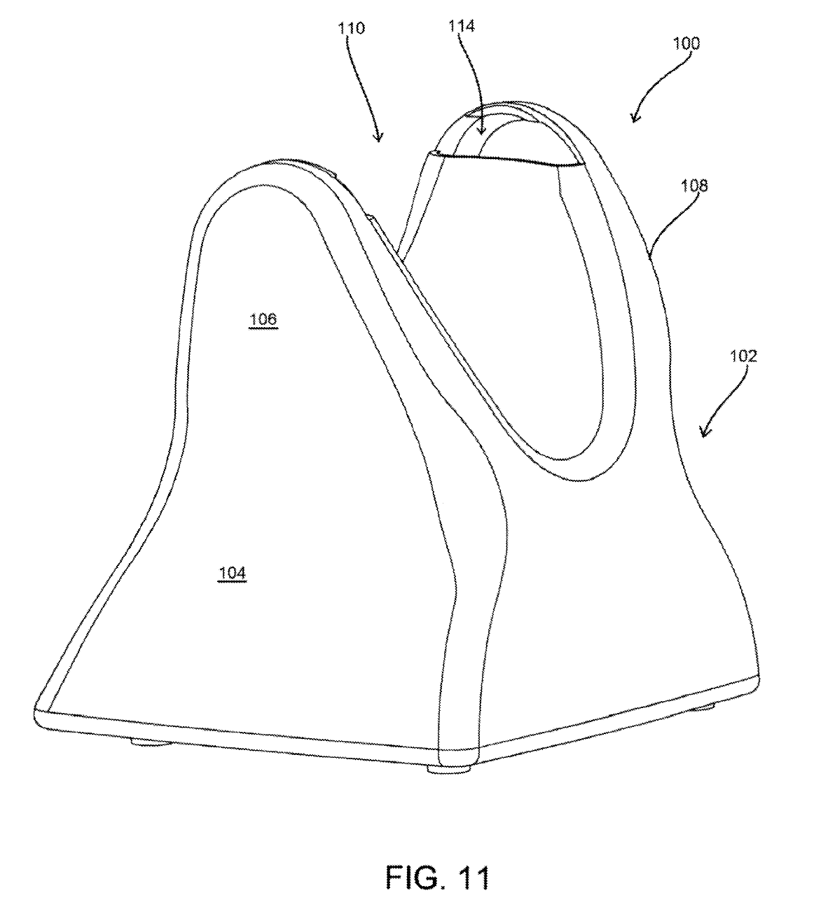

Turning now to FIG. 1, a food processing and preparation apparatus according to an embodiment of the present invention is illustrated generally at 100 and includes a housing 102 formed with a footing portion 104 and two arms 106, 108 projecting upwardly therefrom forming an arm section. The arms are curved upwardly away from the footing portion 104 and together with the footing portion 104 define a generally U-shaped cavity 110 as best seen in FIGS. 8-11 for supporting a vessel illustrated generally at 200. Alternatively, in a not-illustrated version of the food processing and preparation apparatus of the present invention, the arm section can be omitted and the footing portion by itself can define a cavity for supporting the vessel 200.

The vessel 200 is formed as a generally frusto-conical member having walls 202 defining a food chamber 204 therein. A handle 220 is attached to the walls or body 202 for ease of manipulation by a user during cooking operations. A lid 222 is provided for attachment to the vessel for guiding food ingredients retained within the food chamber 204 during operation of the apparatus 100.

The housing 102 is mounted on a chassis 300 including a support platform 302 and a plurality of foot-like support members 304 at each corner of the generally rectangular platform 302. The feet 304 may be formed from a vibration-absorbing material so that vibrations from the apparatus 100 are not transmitted to a supporting countertop.

A control assembly 400 includes a bezel 402 that is mounted to the front of the housing 102. A plurality of switches or buttons 404, 406, 408, 410, 412, 414, 416, 418, 420, 422 are fitted to the bezel 402 in order to provide user-accessible controls for a selection of various functions as will become apparent hereinafter. Two rotatable knobs, 426, 428 are rotatably mounted to internally-encased rheostats or other variable control elements for manipulation by the user to predetermined locations indicated by indicia 430, 432 on the bezel 402 and knobs 426, 428 for further control of operation of the apparatus 100. A display 424 may be a liquid crystal diode (LCD), that may optionally have touch-screen capabilities, or another display unit capable of presenting information related to operation of the apparatus 100.

As will be seen in greater detail hereinafter, the food processing and preparation apparatus 100 can receive food in an unfinished state, weigh the ingredients, mix the ingredients, and apply heating or cooling as necessary over a predetermined time period all in accordance with a predetermined recipe to achieve a finished dish for immediate serving or an intermediate stage dish for further cooking such as oven baking. The predetermined recipe may be a recipe that has been programmed by the user or that has been internally stored, or that has been received from an external communication medium such as the Worldwide web (Internet) or other source such as a home computer. It is contemplated that the present invention will have a USB or other type Internet connection such that the food processing and preparation apparatus 100 may be connected directly to the Internet or it may be connected through a home computer such as a laptop computer for receiving instructions such as recipes that are predetermined with respect to the present apparatus 100 for storage and memory for later retrieval and use. Firmware updates can also be transmitted to the unit via some form of Internet connection.

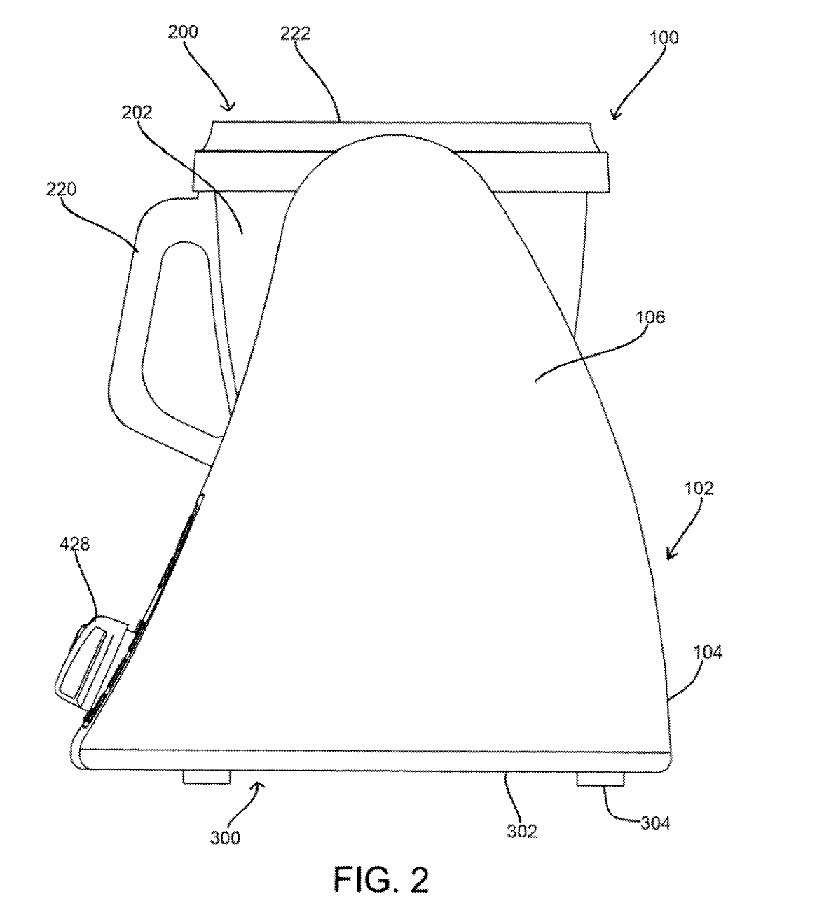

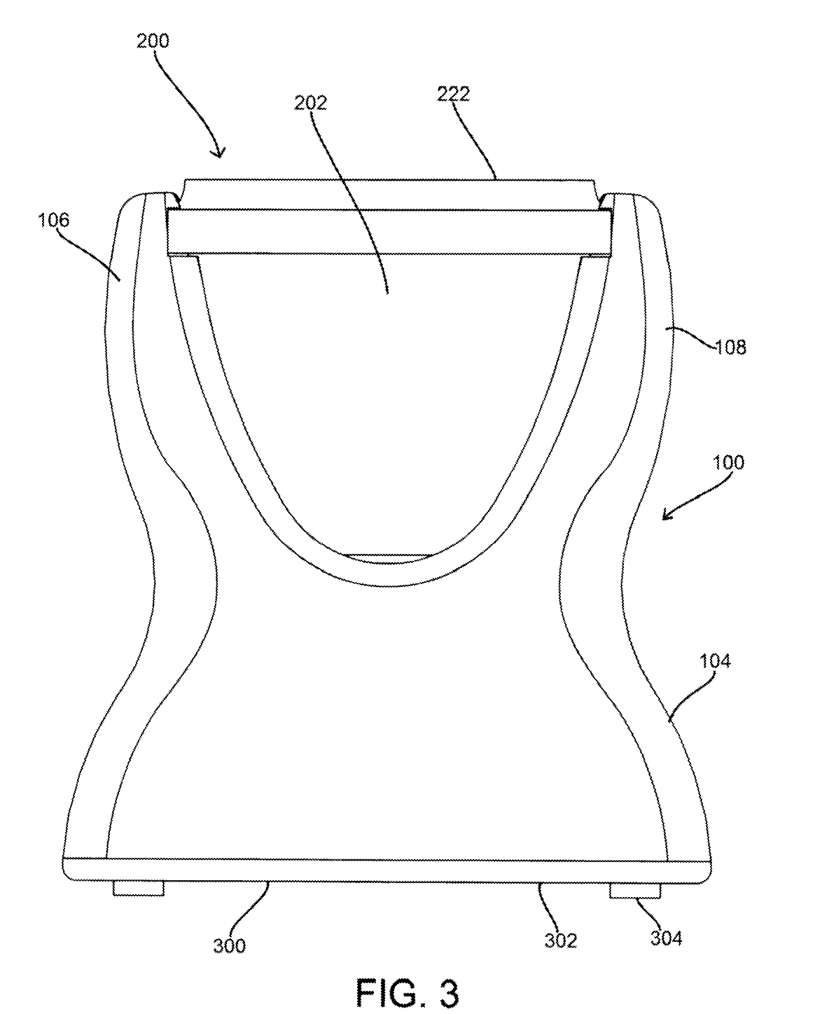

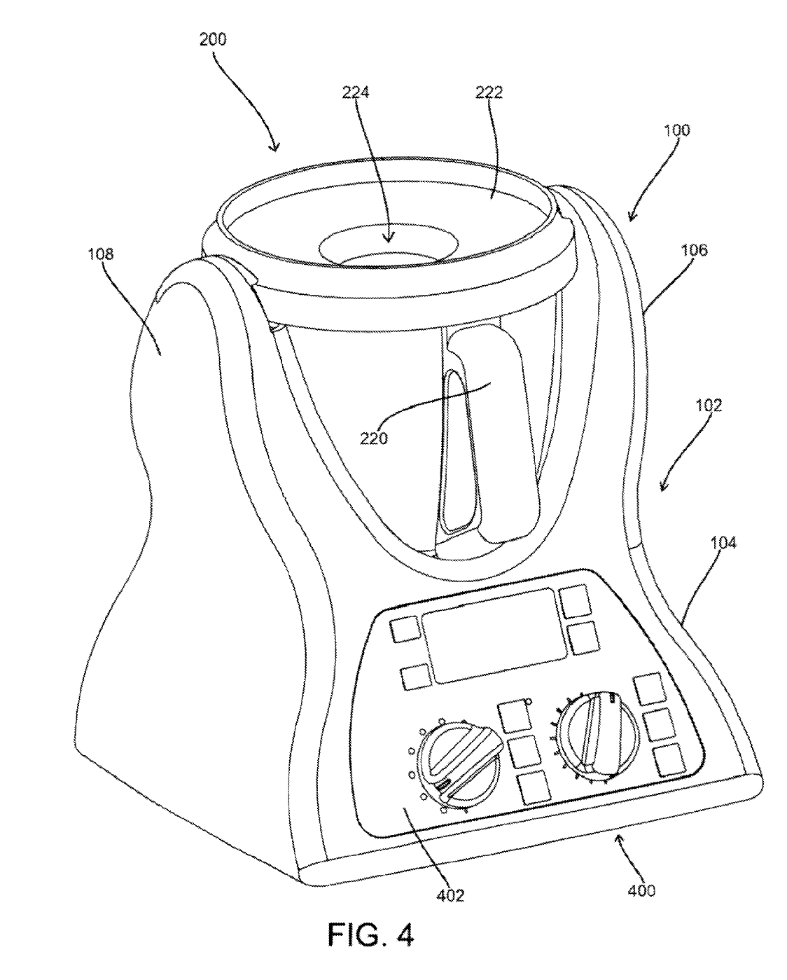

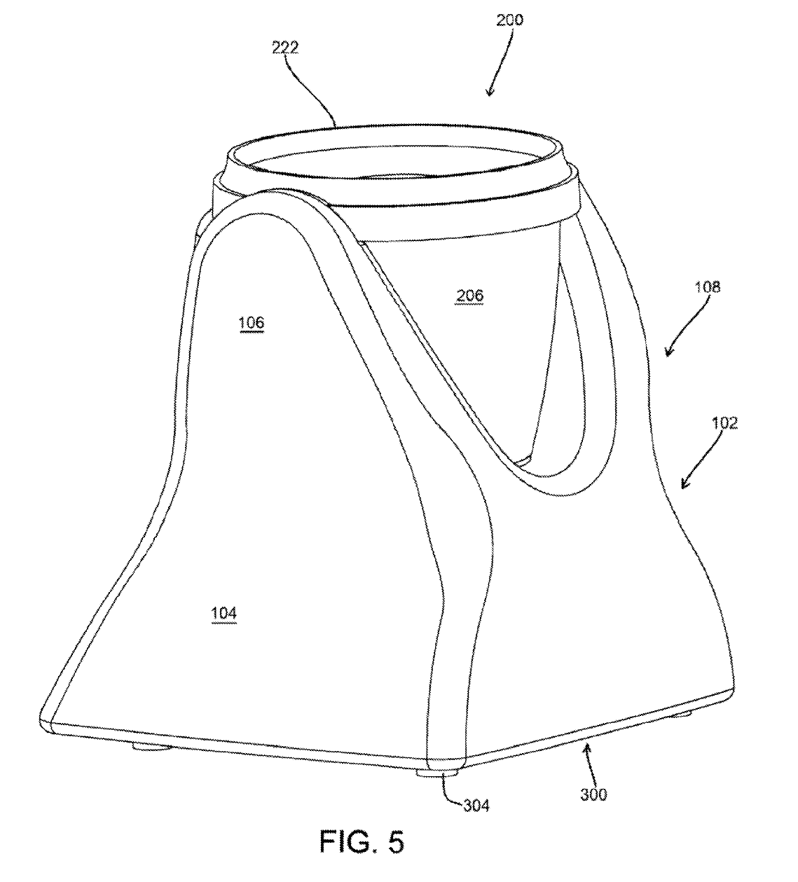

FIGS. 2, 3, 4 and 5 illustrate various aspects of the food processing and preparation apparatus 100 from various viewing angles. With respect to FIG. 4, it can be seen that an opening 224 is provided in the center of the lid 222 for inserting ingredients while the lid remains locked in place on the upwardly projecting arms 106, 108. Optionally, a plug which may be in the form of a measuring cup is provided to close the opening 224 during use. As seen in FIGS. 8, 9, 10 and 11, notches 114 are provided in the upper limits of each arm 106, 108 in order to receive a portion of the lid, thereby locking the lid in place and preventing movement of the vessel as the mixer applies rotation to the vessel contents via the mixing arrangement.

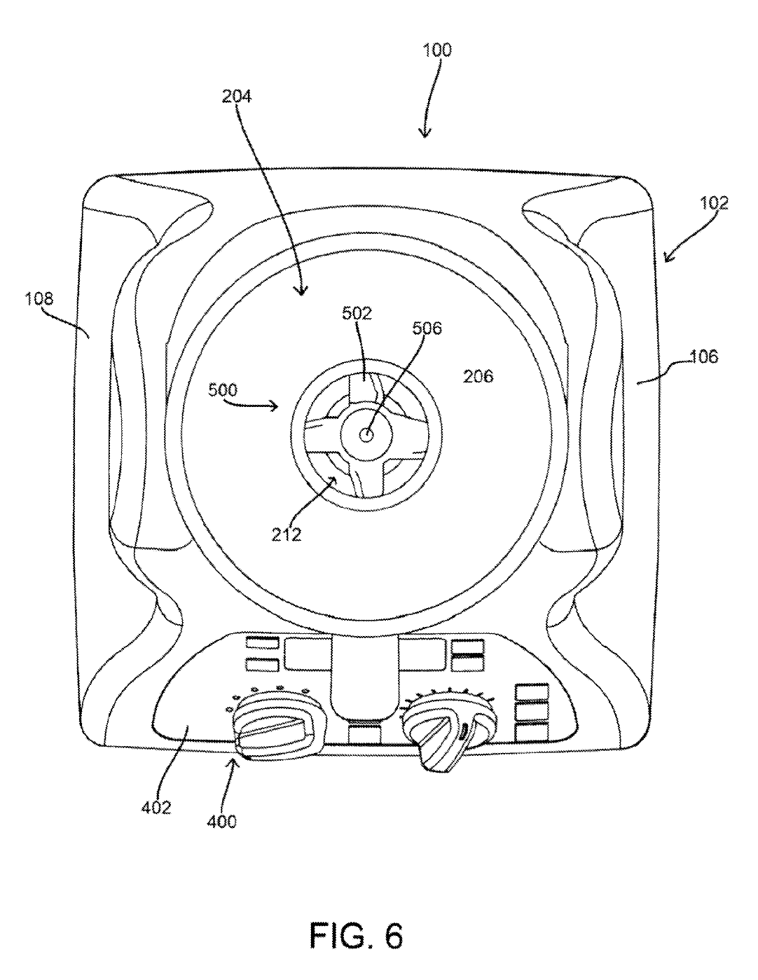

As seen in FIG. 6, a blade movement system 500 is provided that is operable to selectively rotate a rotatable blade 502. The blade 502 is fixedly secured to a mechanical connector 506 that is mounted within an opening 212 at the base of the vessel walls 206 within the food chamber 204. The blade 502 is fixedly secured to the mechanical connector 506 such that driving rotation of the blade 502 is effected via rotation of the mechanical connector 506 by an electric motor, as will be explained in more detail below.

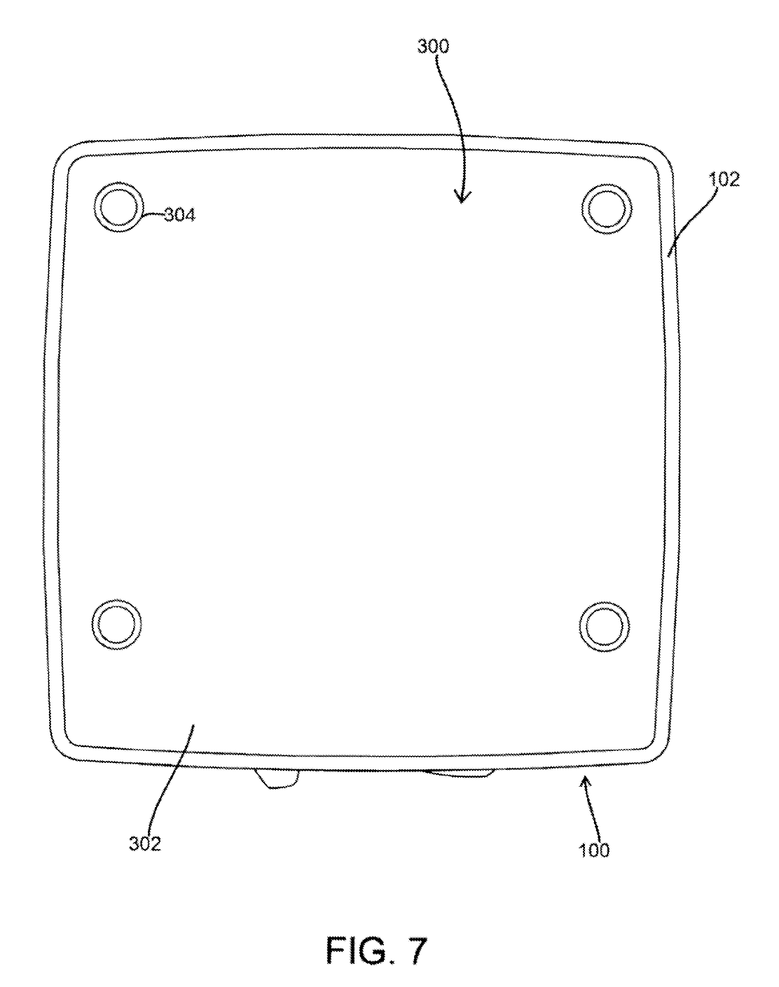

FIG. 7 is illustrative of the chassis 300 of the food processing and preparation apparatus 100 to which the housing 102 is mounted. The chassis 300 includes the platform 302 which covers the opening in the bottom of the body 202 and provides a mounting arrangement for the support feet 304.

As seen in FIG. 8, a drive shaft 508 projects upwardly from the central base of the cavity 110 for engagement with the connector or spindle 506 to cause rotation of the blades 502 as will be explained in greater detail hereinafter. As can be seen in FIG. 8 as well, the notches 114 formed in the arms 106, 108 include shoulder elements to support the lid 222 at both a bottom portion and a top portion of the lid 222 to secure the lid 222 against movement induced by vibration of the food processing and preparation apparatus 100.

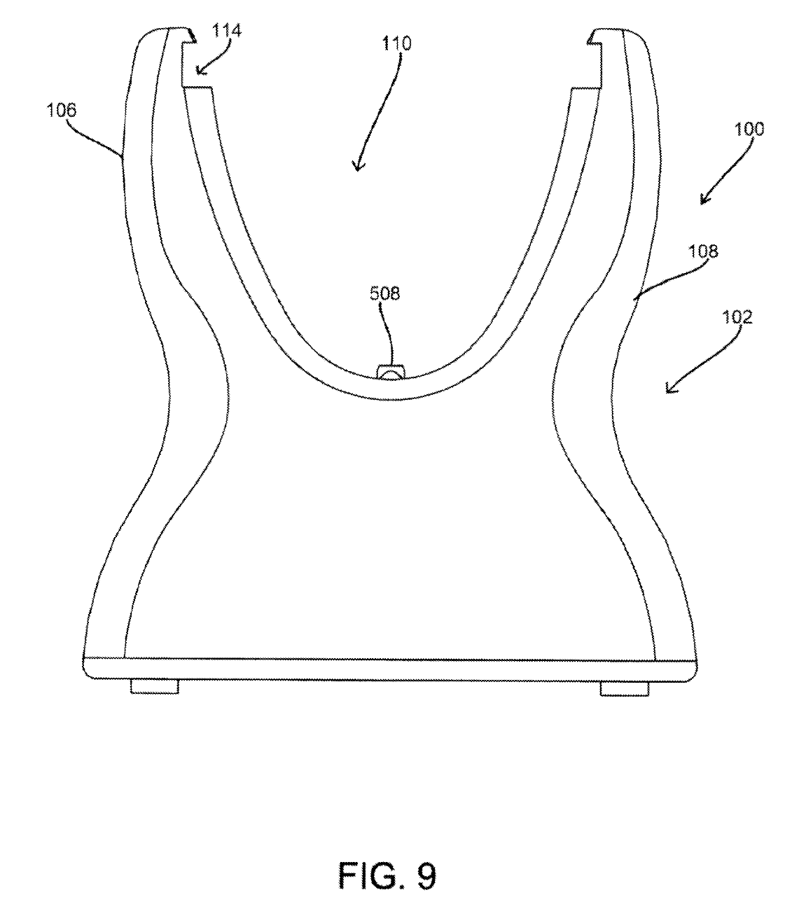

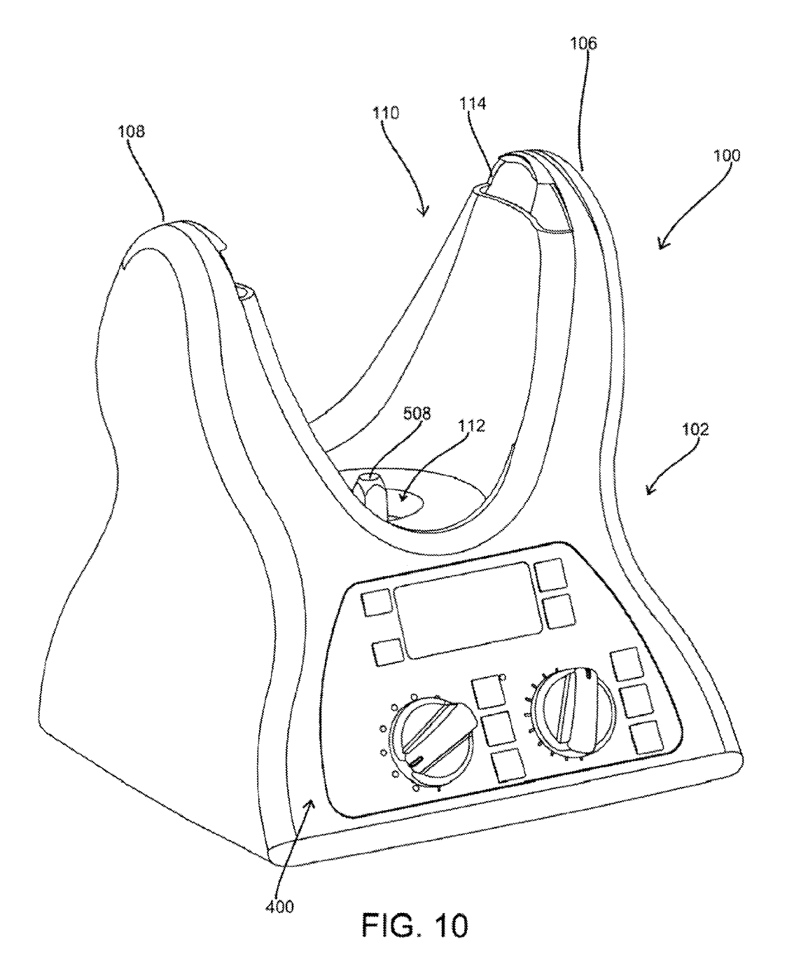

FIGS. 9-11 provide further illustration of the food processing and preparation apparatus 100 with the vessel 222 removed. FIG. 10 is of interest for its disclosure of the drive spindle 508 projecting upwardly through the opening 112 within the cavity 110.

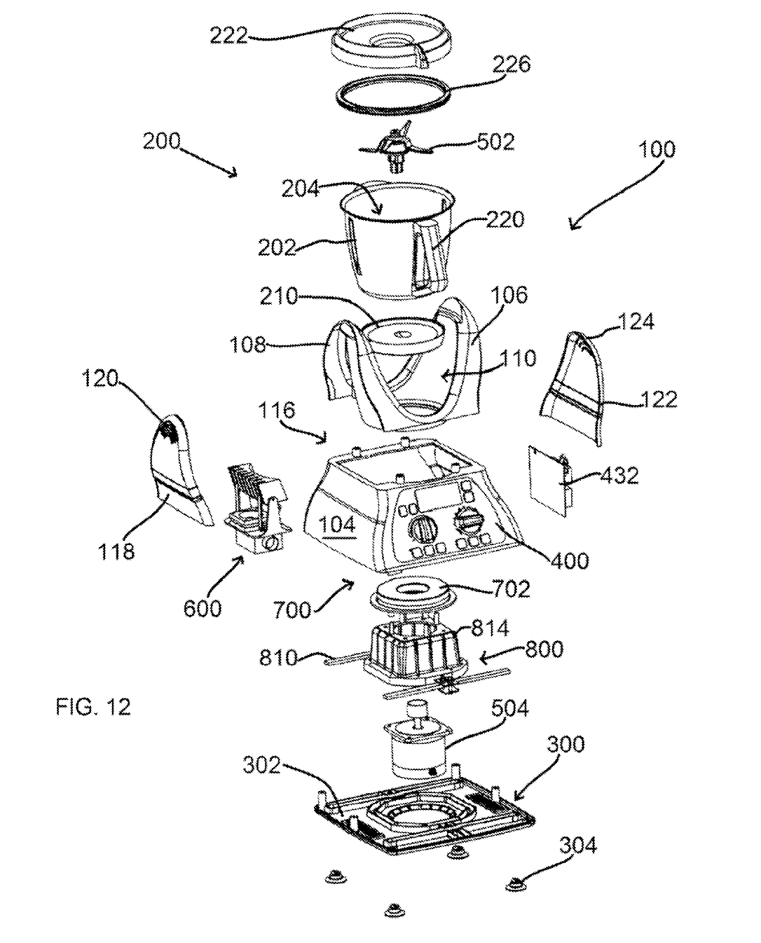

With reference to FIG. 12, the food processing and preparation apparatus 100 is illustrated in an exploded manner revealing the contents of the housing 102 and the several operative systems. The housing 102 has the footing potion 104 and the two arms 106, 108 projecting upwardly from the base unit. Both the footing portion 104 and the two arms 106, 108 taper into a region where they are joined to form the housing 102, the region defining a trunk transition location 116 having a narrower lateral extent than that of the arms 106, 108 and the base of the housing 104. The narrow trunk transition location 116 functions as a gripping area to allow a user to position a hand on a respective one of the two arms 106, 108 and then lift and carry the food processing and preparation apparatus 100 in a balanced manner.

The chassis 300 includes a platform 302 with a plurality of feet 304 each at a respective one of the four corners of the substantially rectangular platform 302 that is fitted to the base of the housing 104. A motor 504 for the blade movement system 500 is fitted to the center of the platform 302 with the armature of the motor projecting upwardly for engagement with blades as will be seen in greater detail hereinafter.

The weighing system 800 is also mounted to the platform 302 and includes two laterally extending rails 810 fitted to a dome 814 over the motor 504 and mounted to the platform 302. The heater system 700 includes a generally toroidal heating element 702 mounted to the weighing system 800.

The arms 108, 106, which extend above the trunk transition location 116, form the cavity 110 for fitment of the vessel 200. The vessel 200 includes a removable base 210 and a handle 220 is attached to a side wall or body 202 of the vessel 200. The blades 502 fit within the center of the base 210 of the vessel in operative communication with the motor 504. The lid 222 is fitted to the round upper rim of the vessel body 202 with a gasket 226 fitted therebetween for reducing to the point of completely sealing the food chamber 204 from exposure to the external environment outside the food chamber 204.

The arms 106, 108 define cavities within the arm structure that are covered by removable panels 118, 122 with each of the removable panels 118, 122 having ventilation openings 120, 124 respectively formed therein.

A control board formed as a printed circuit board 432 is fitted on one arm structure 106 and covered by a panel 122. The integrated circuit of the control system 400 allows the user extreme versatility with respect to operation of the food processing and preparation apparatus 100 as will be seen in greater detail hereinafter.

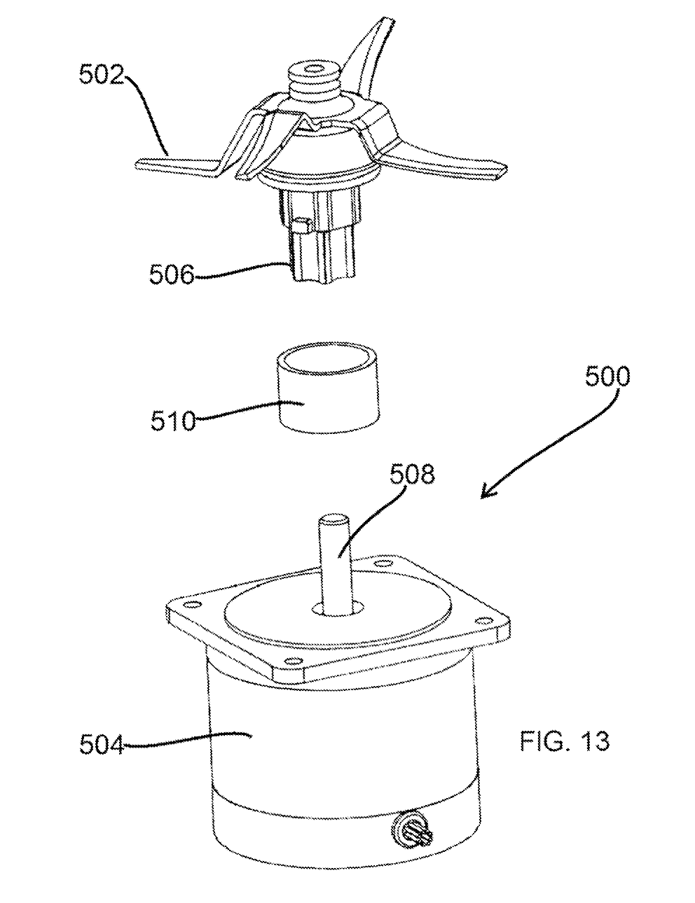

More details are now provided on the individual systems that operate on, or handle, foodstuffs within the food chamber 204 of the vessel 200 when the food processing and preparation apparatus 100 is in use. Turning now to FIG. 13, the blade movement system 500 includes an electric motor 504 and an intermediary element in the form of a drive spindle 508 projecting from the electric motor 504. The drive spindle 508 is attached to the armature of the electric motor in a known manner. The electric motor 504 is arranged with the drive spindle 508 projecting vertically so that the blade 502 may be fitted in a manner for engaging foodstuffs within the vessel 200 as seen in FIG. 12. A bushing 510 is placed over a mechanical connector 506 projecting downwardly from the blades 502. The mechanical connector 506 engages the drive spindle 508 so that rotation of the armature of the motor causes rotation of the drive spindle 508, which, in turn, causes rotation of the mechanical connector 506, and rotation of the mechanical connector 506 causes rotation of the blades 502.

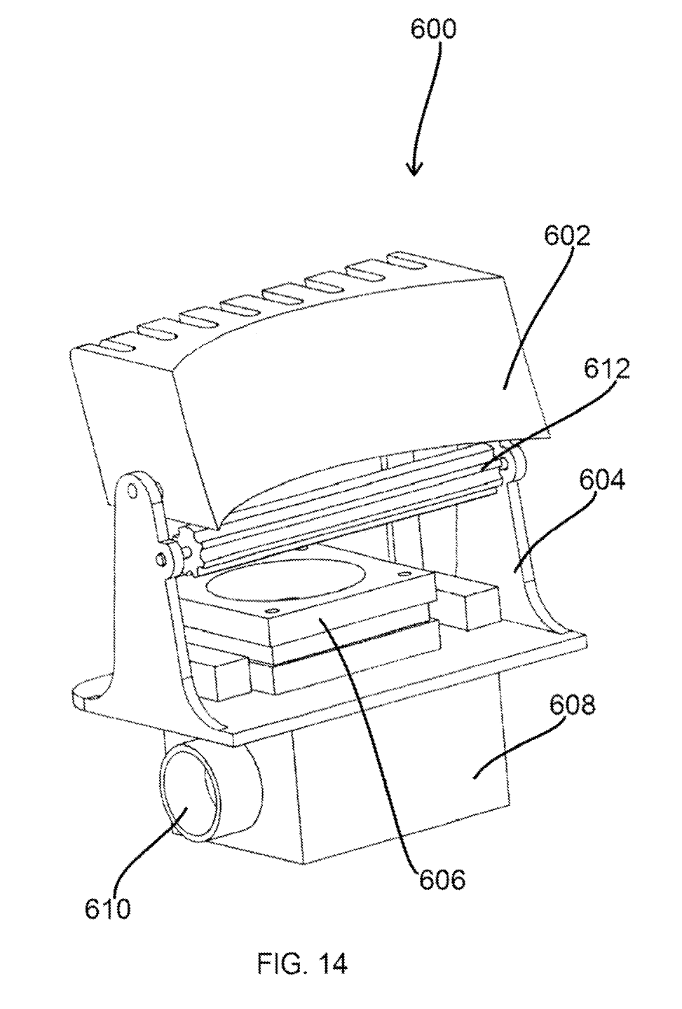

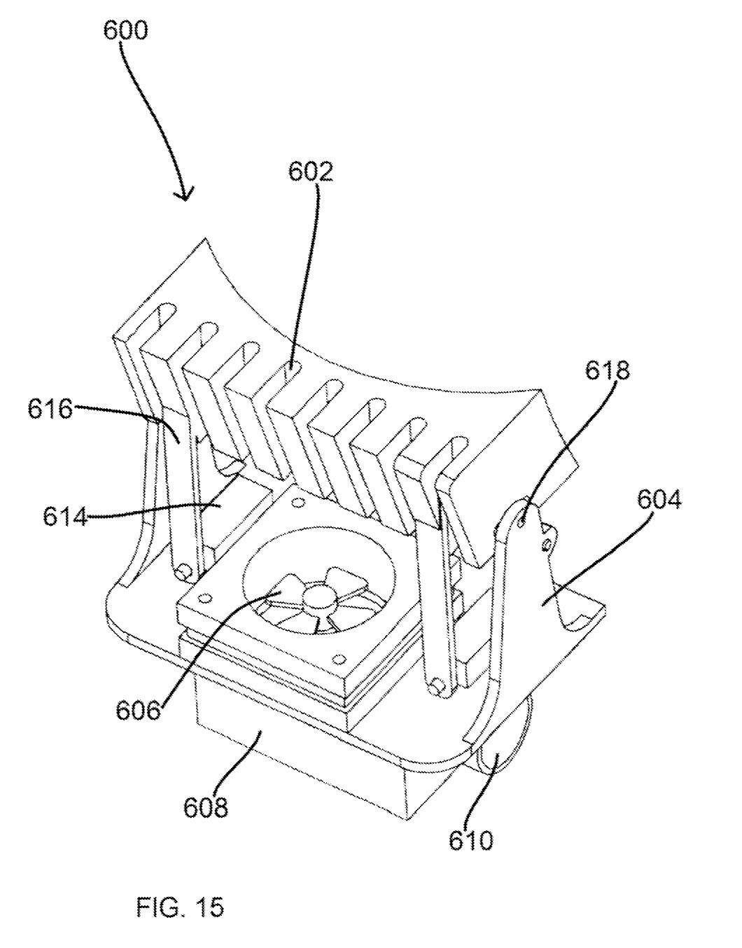

Turning now to FIGS. 14 and 15, the cooling system 600 is illustrated as a modular component including a heat sink 602 mounted to a fan assembly 606 and a plenum 608 using upwardly projecting arms 604. The plenum 608 directs air inwardly or outwardly through a nozzle 610 toward or away from the heat sink 602 as selected by the control system 400. A wick 612 extends across a region below the heat sink 602 for contact with the vessel body 202. The heat sink 602 is curved in a manner to maximize a surface contact area with the vessel body 202. The heat sink 602 may be fitted with a heat exchange assembly operable to selectively retain and release heat that may be in the form of a Peltier module, this heat exchange assembly operating to chill foodstuffs and to conduct heat away from the vessel body 202 via the heat sink 602. The wick 612 is configured for contact with the vessel body 202 in order to absorb condensation therefrom. The wick 612 is disposed within the air stream between the fan 606 and the heat sink 602, as seen in FIGS. 14 and 15. The selectively movable heat sink 602 is mounted to a pair of solenoids 614 using support arms 616. The heat sink 602 is mounted to its own support arm 604 in a pivotal manner at a single pivot point 618. Energizing the solenoids 614 will cause the arms 616 to retract or advance the heat sink 606 into and out of contact with the vessel body 202.

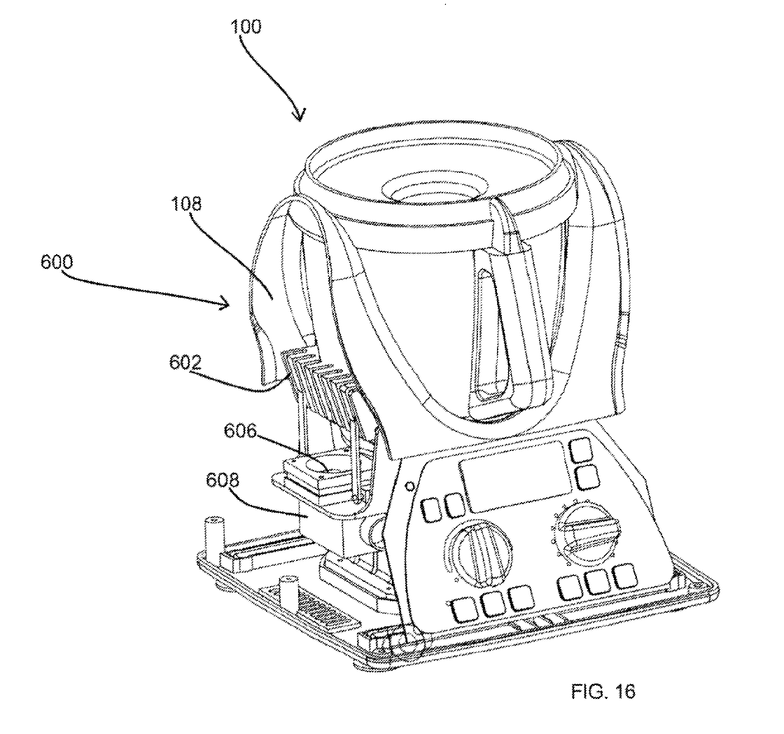

The cooling system 600 assists air flow to benefit the operation of the food processing and preparation apparatus 100 at specific times. When the cooling system is engaged with the vessel body 202, the fan 608 will blow or pull heat from the motor and electronics and keep it away from the vessel 200. When not in use, the cooling system 600 will change the direction of air flow and use the heat produced by the motor and electronics to heat upper portions of the vessel 200 for better heat distribution to the vessel 200 contents when the heating unit is engaged. This will be explained in greater detail hereinafter. Turning now to FIG. 16 it can be seen that the cooling system 600 is mounted to the inner portions of housing base portion 104 with the heat sink 602 extending upwardly into the arm portion cavity 108.

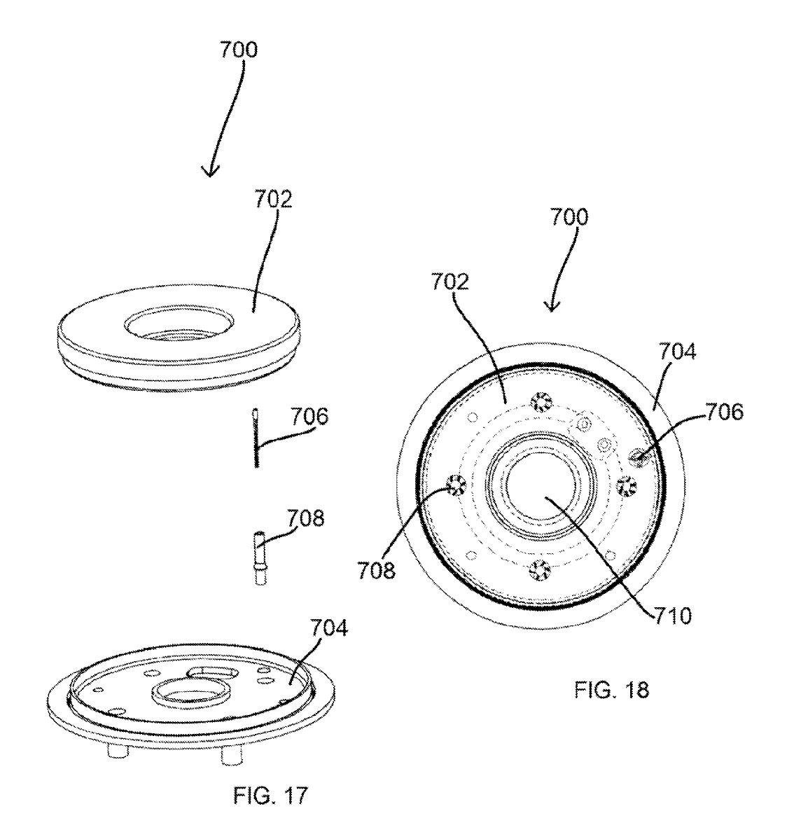

Referring to FIGS. 17 and 18, the heating system is illustrated generally at 700 and includes a circular washer-like mounting plate 704 and a toroidal heating element 702. The heating element 702 may be formed from cast aluminum. A sensor 706 is used to sense the temperature of the heating element 702 during operation and includes a sensor clip 708 to attach the sensor 706 to the platform 704 for contact with the heater element 702. FIG. 18 illustrates a top plan view of the heating element 700 and the sensor location 706 is illustrated.

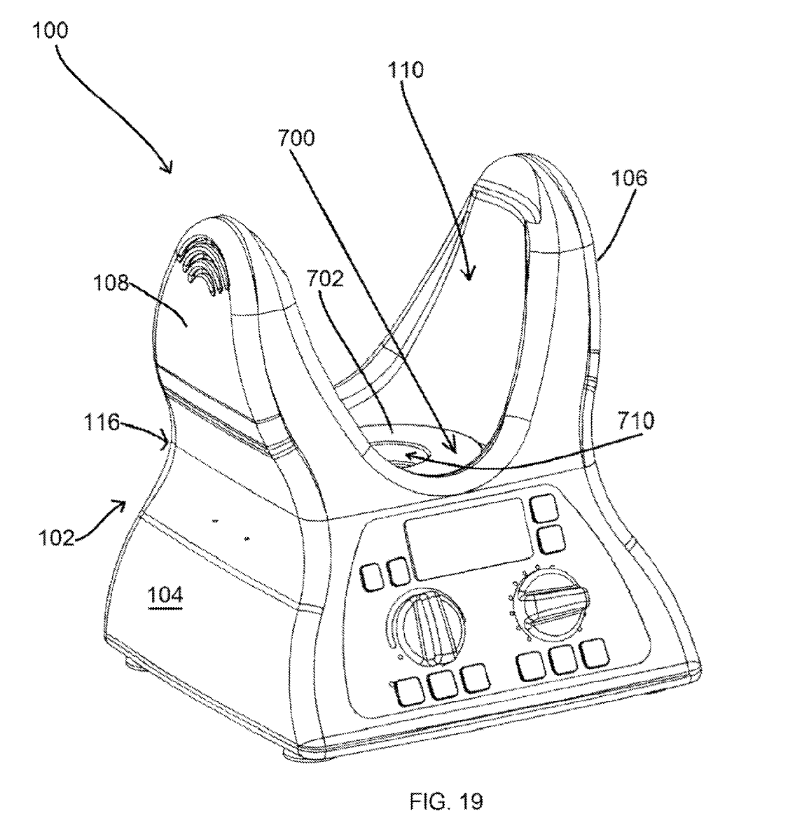

Turning now to FIG. 19, the heating element 702 is mounted with the heating system 700 within the vessel cavity 110 formed by the arms 106, 108 of the housing 102 of the food processing and preparation apparatus 100. An opening 710 extends through the heating element 702 and the support platform 704 so that the drive spindle 508 and the blade mechanical connector 506 may project through the heater element 702 and the platform 704 for simultaneous and cooperative operation of both systems.

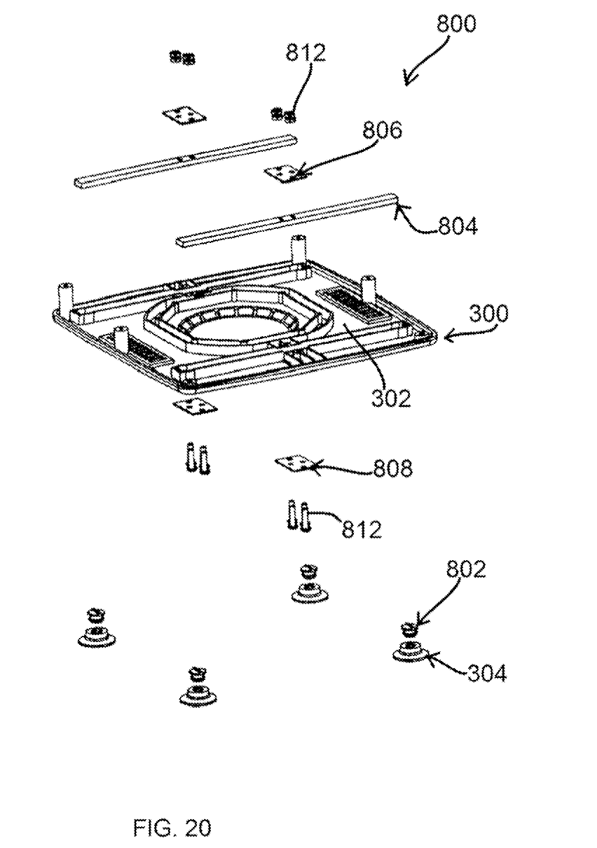

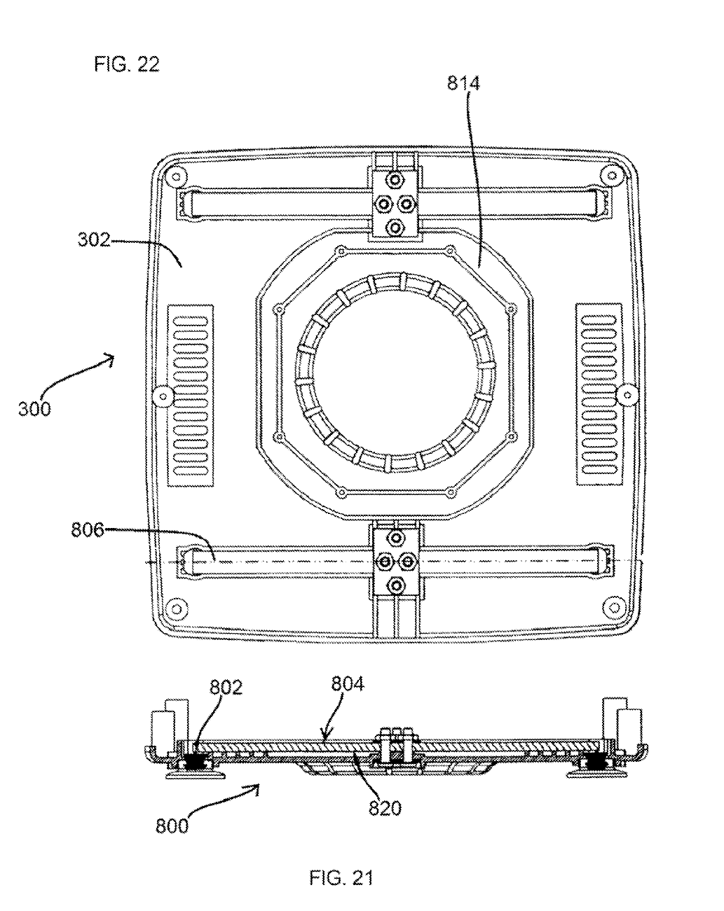

Turning now to FIG. 20, the weighing system 800 is illustrated in an exploded manner. The weighing system includes two aluminum bars 804 extending generally parallel to one another along the sides of the platform 302 of the chassis 300. The bars 804 are mounted to the platform 302 using a top steel plate 806 and a bottom steel plate 808 using fastening elements 810 and 812. The bars are fitted at each distal end with a stainless steel foot element 802 fitted within the suction cup feet 304. Strain gauges 820 are fitted to the bars 804 as seen in FIG. 21.

FIG. 22 illustrates a top plan view of the weighing system 800 in its final assembled state in the food processing and preparation apparatus 100 and including a heating element support dome 814 as seen in FIG. 12 and FIG. 22. The vessel 200 ultimately rests on the heating element support dome 814 and is therefore supported by the aluminum bars 804. The bars 804 bend downwardly under the weight of the vessel 200 and its contents and the magnitude of the displacement of a bending bar 804 in its bent conditioned is registered by a strain gauge 820 and directed to the control circuit 432 for use in operation of the present food processing and preparation apparatus 100.

The foregoing addressed internal components of the present food processing and preparation apparatus 100. It should also be noted that the control circuit 432 may include a clock timer and other transistors, switches, RAM, ROM and components as necessary to act as the control of the food processing and preparation apparatus 100 to perform various functions and necessary orders, in varied sequences and at predetermined or selected times. The controls are influenced by weight and temperature and act to control the temperature and mixing of foodstuffs within the vessel 200. The following discussion focuses on external accessories and other apparatus that enhance the versatility of the food processing and preparation apparatus 100 as presented above.

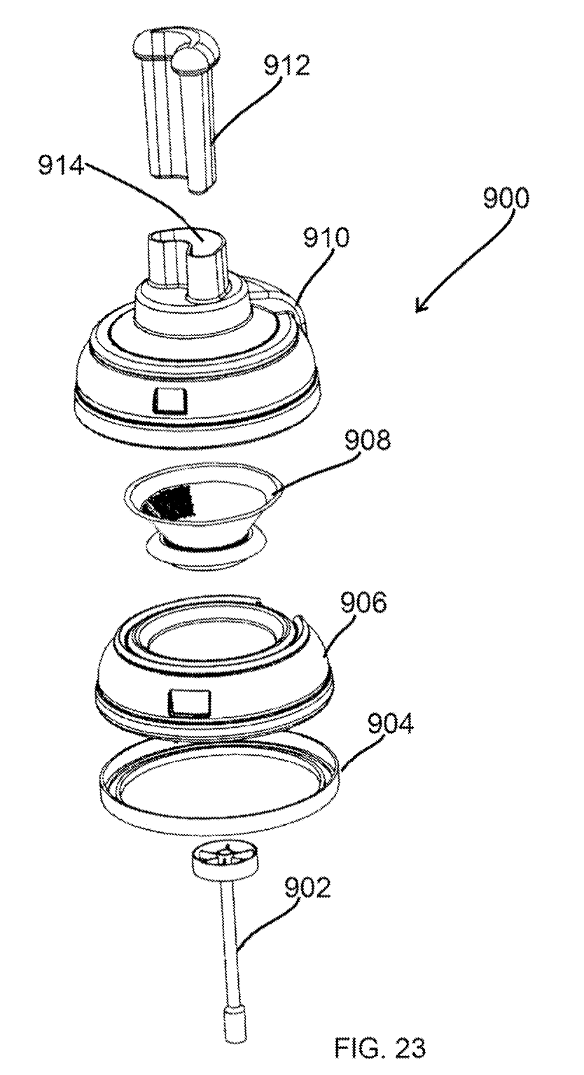

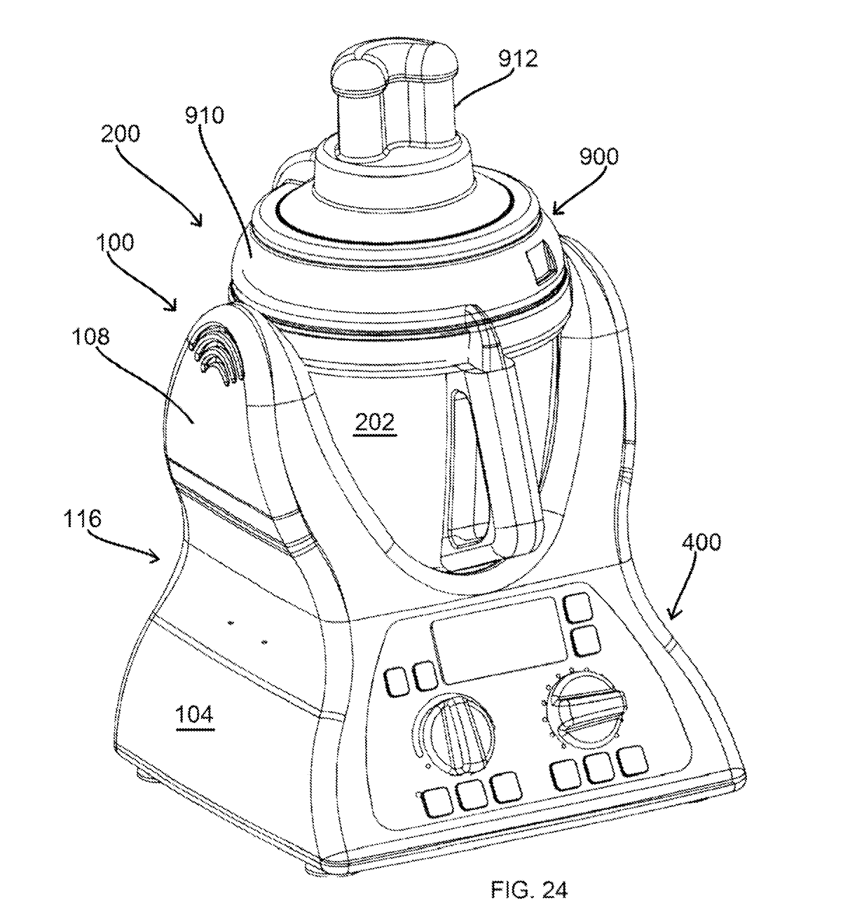

As seen in FIG. 23, a juicer attachment is illustrated generally at 900 in an exploded form. From the base, the juicer 900 includes a stirring spindle 902 for operational engagement with the drive motor 504. A lower housing 906 is fitted to a vessel interface 904 for mounting the juicer 900 to the vessel 200 as seen in FIG. 24.

With continued reference to FIG. 23, an upper housing 910 is mounted to the lower housing 906 with a strainer and grinder element 908 contained within the housing components 910, 906 for engagement with the draft or stirring spindle 902 for rotary motion thereof. Elements for juicing may be placed in to the strainer and grinder 908 when the top 910 is removed. Further, the top 910 includes an access opening 914 which is generally in the shape of a geometric figure having no corners and which is not in the shape of a circle. A plunger 912 is formed with a shape complementary to the shape of the access opening 914 such that registry of the plunger 912 with the access opening 914 is facilitated. The plunger 912 is operable to be moved relatively past the access opening 914 in extension and retraction movements to contact and displace foodstuffs in the strainer and grinder 908. Elongated items may be placed in the opening 914 and driven into the strainer and grinder 908 using the plunger 912 in a vertically reciprocating manner. Additionally, the plunger 912 may be simply held downwardly against the contents of the juicer while the strainer and grinder 908 rotates to produce juice within the vessel 200 with the juice being derived from any respective ingredients chosen by the user.

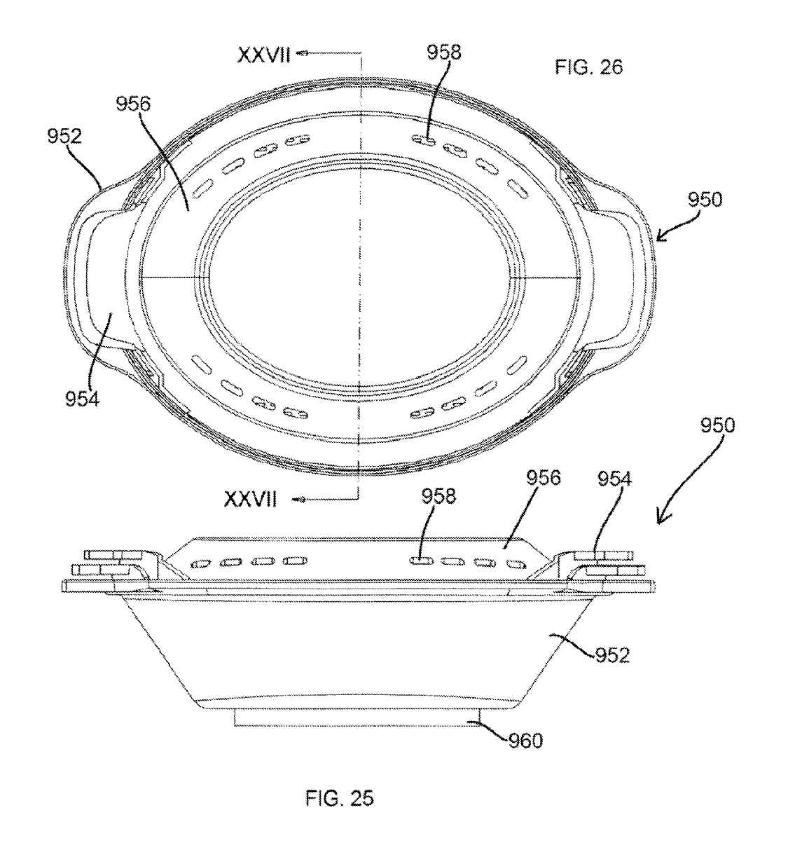

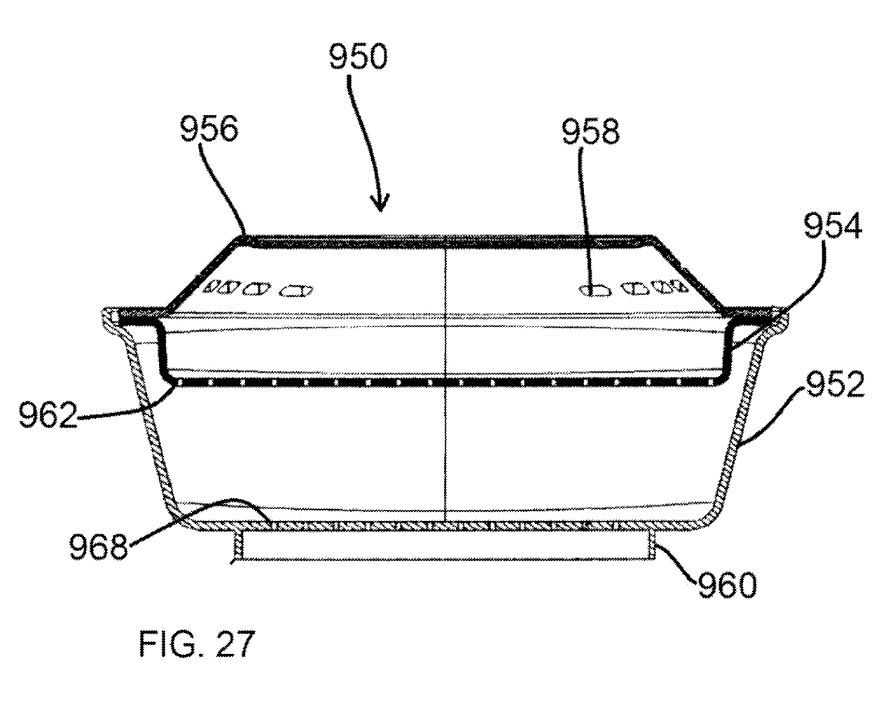

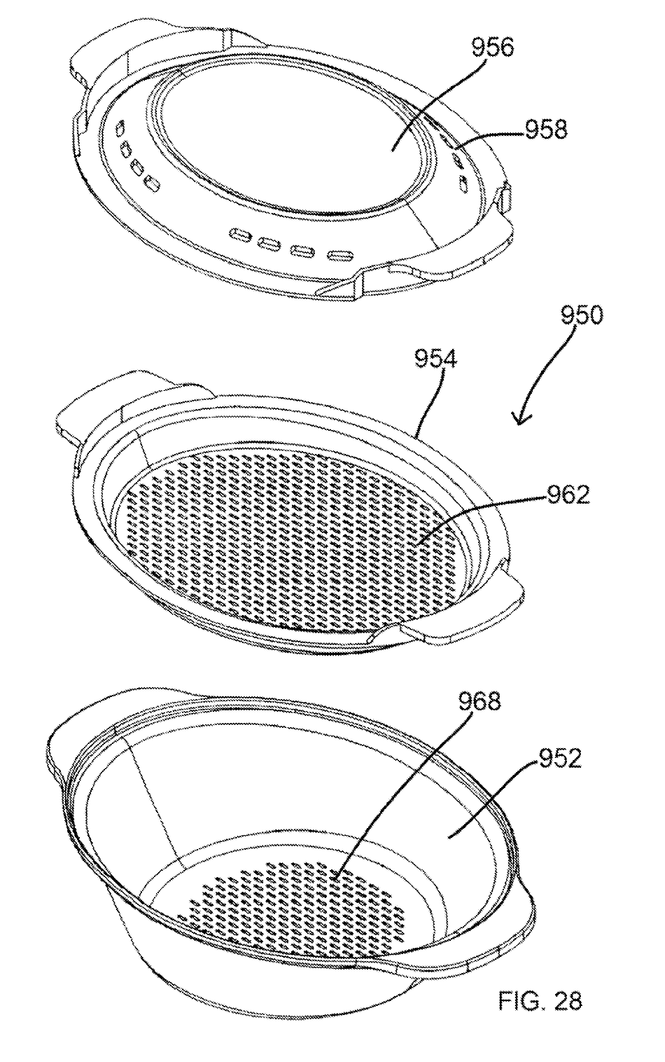

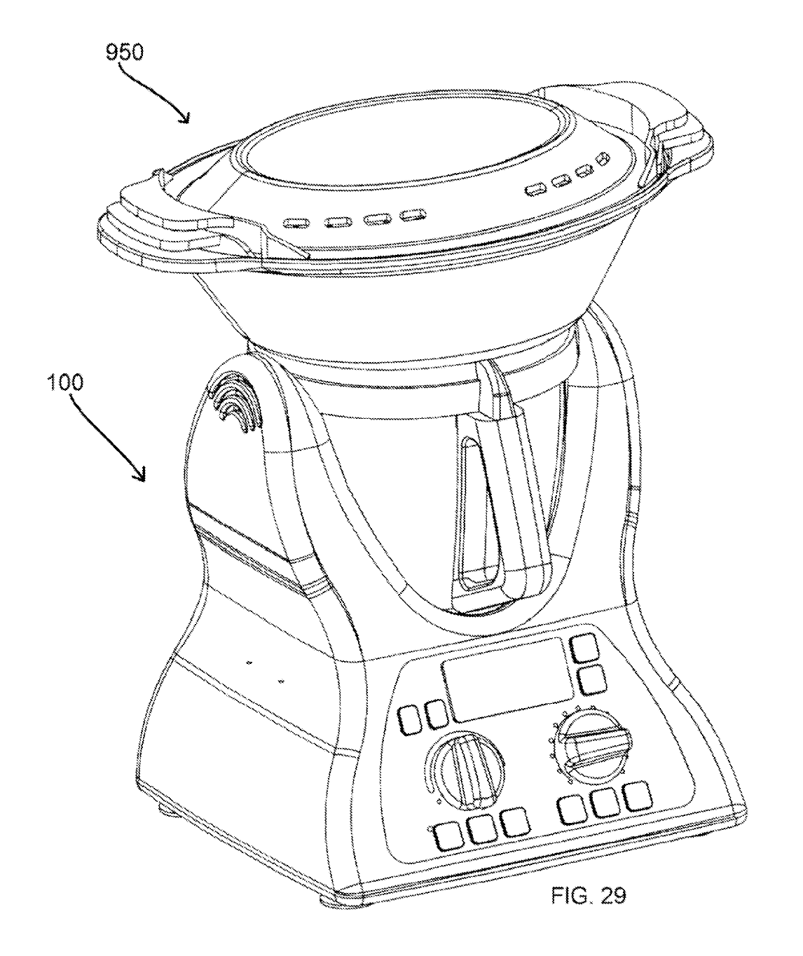

Turning now to FIGS. 25, 26 and 27, a steamer system 950 is illustrated. As seen in FIG. 25, the steamer system 950 includes a first level food container 952 formed as a generally bowl-like structure having a plurality of vents 968 formed in a base portion thereof. A mounting ring 960 is formed on the base of the first level food container 952 for engagement with the vessel 200 as seen in FIG. 29. A second level food container 954 is nested with the first level food container 952. The second level food container 954 is formed with a plurality of vents 962 in the base thereof. A top 956 is fitted to the second level food container 954. Vents 958 are formed in the top so that steam directed from the vessel 200 into the first level food container 952 may pass through the vents 962 in the second level food container 954 thereby steaming the contents of the second level food container 954, with spent or exhausted steam passing outwardly through the vents 958 in the top. FIG. 28 illustrates the steamer 950 in an exploded form and provides a clear view of the vents 968 in the base of the first level food container 952 and the vents 962 in the base of the second level food container 954. Water that is boiled in the vessel 200 (i.e., water brought to a temperature of 212 degrees Fahrenheit or 100 degrees Centigrade) using the heating system 700 creates steam through the vents 968 thereby steaming the contents of the first level food container 952 wherein steam passes through the vents 962 of the second level food container 954 to steam the contents thereof before escaping through the vents 958 in the top 956. FIG. 27, which is a side cut-away view of the steamer arrangement taken along lines XXVII-XXVII in FIG. 26, shows the second level food container 954 nested with the first level food container 952. FIG. 29 illustrates the relationship between the steamer 950 and the remainder of the food processing and preparation apparatus 100 when the steamer 950 is in use.

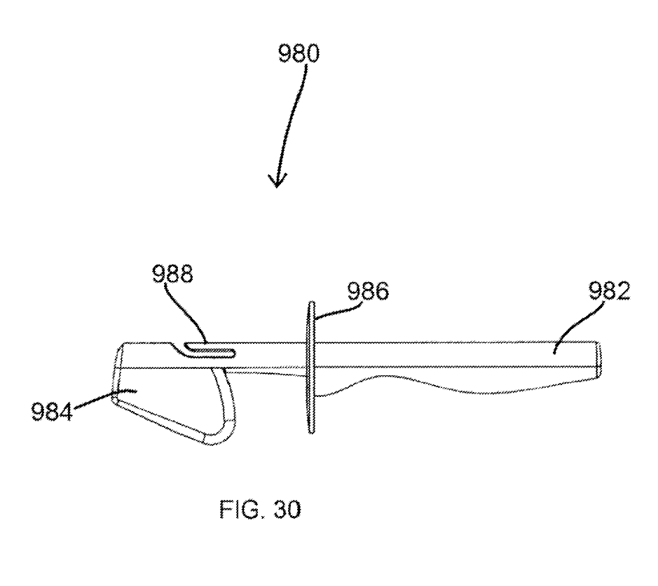

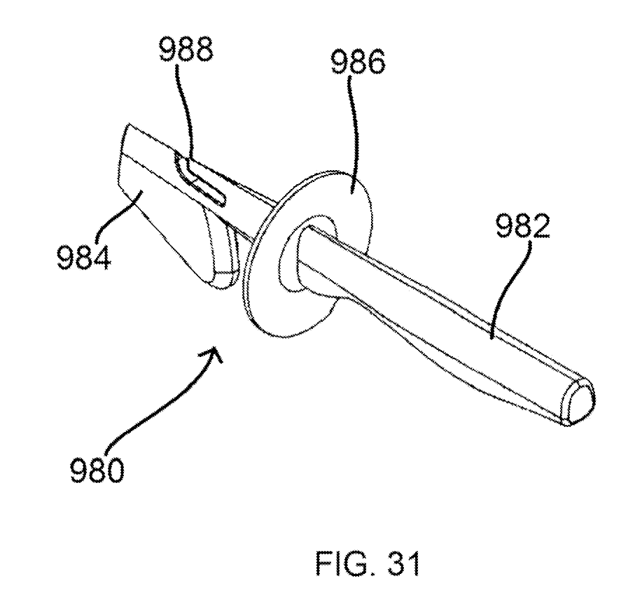

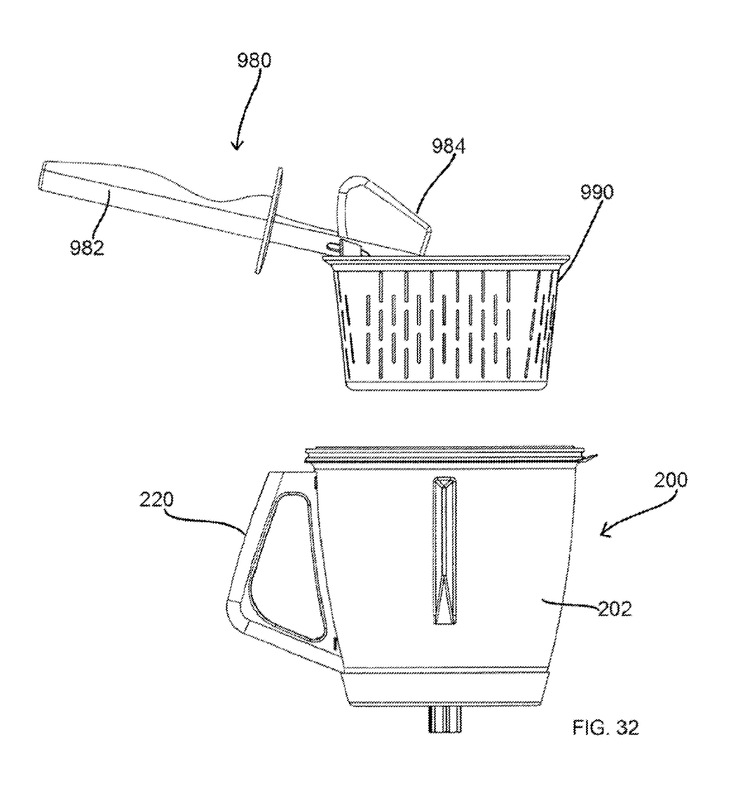

With reference to FIGS. 30 and 31, the present invention includes an accessory formed as a spatula 980. The spatula 980 includes a generally elongate handle portion 982 and a blade 984 formed from rubber or other resilient material illustrated at 984. The blade 984 is mounted to the distal end of the handle 982 and projects outwardly laterally away therefrom in the manner of a fin. The spatula blade 984 is contoured with the blade 984 forming an angle with the horizontal in a manner to form fit with the walls 202 of the vessel 200. A guard element 986 is fitted to the handle 982 to extend circumferentially thereabout and provide a shield to keep the spatula from reaching the blades 502. A hook 986 is formed in the handle 982 oppositely from the blade 984 for engagement with a basket as will be seen in greater detail hereinafter.

Turning now to FIG. 32, the spatula 980 is shown engaged with a basket colander 990 with the basket colander 990 interlocked with the hook 988 and the spatula blade 984 projecting upwardly. The spatula 980 can therefore stabilize the basket colander 990 for insertion into the vessel 200 when the basket colander 990 contains foodstuffs for processing, preparation, or both processing and preparation by the food processing and preparation apparatus 100.

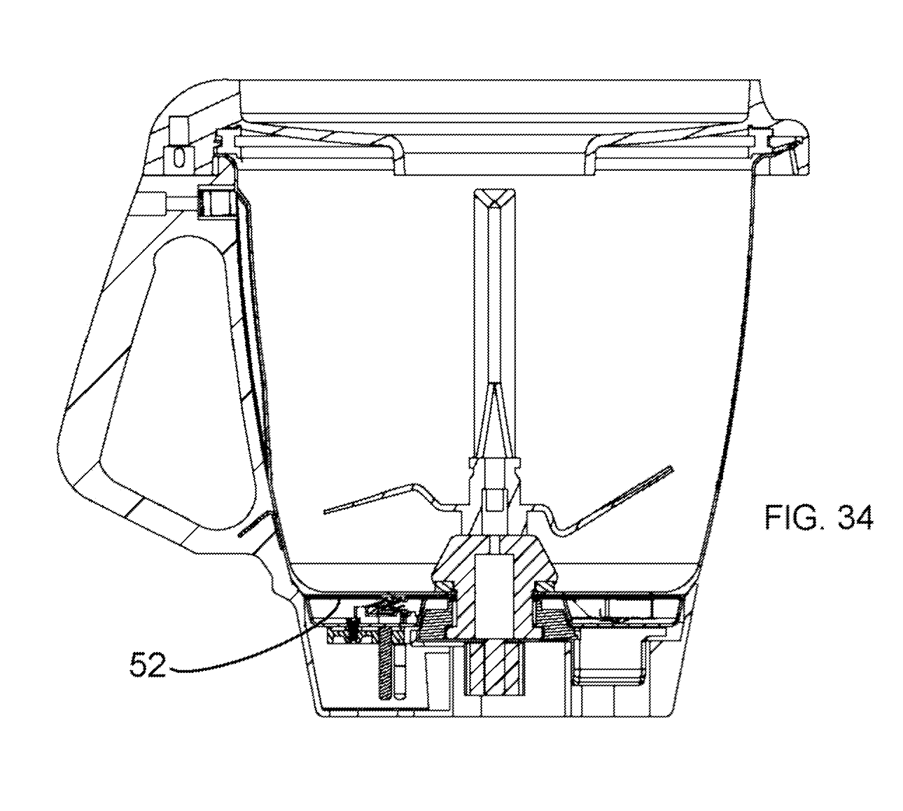

Attention is now drawn to FIGS. 34-36, which illustrate a heating system 50 for handling the heating requirements of the food processing and preparation apparatus 100. The heating system 50 is an alternative arrangement that can be deployed to meet the heating requirements of the food processing and preparation apparatus 100 in lieu of the heating system 700. The heating system 50 is configured with an active thermal element that is located in the vessel 200 and is supplied with power from a contact arrangement that is in contact with a power supply supported on the platform 302. By virtue of this arrangement, the heating system 50 provides a reliable configuration that is impermeable to water or fluid penetration while optimally imposing only a small additional weight impact to the vessel 200. The heating system 50 includes a disc heating element 52 having a toroidal shape with a central opening and a stainless steel case 54 with a central opening. The stainless steel case 54 is compatibly configured with respect to the disc heating element 52 such that the disc heating element 52 is seated within an annular valley of the stainless steel case and the central openings of the stainless steel case and the disc heating element are coincident with one another.

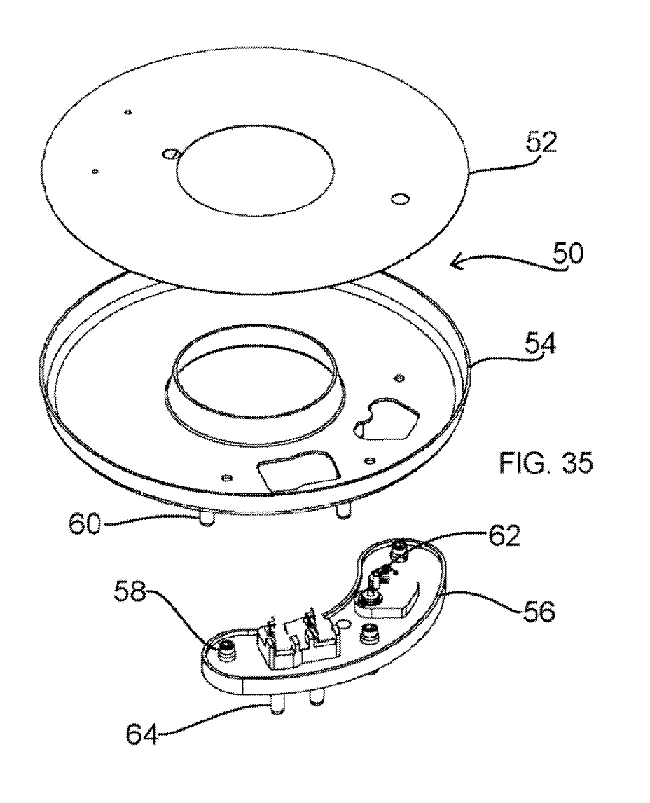

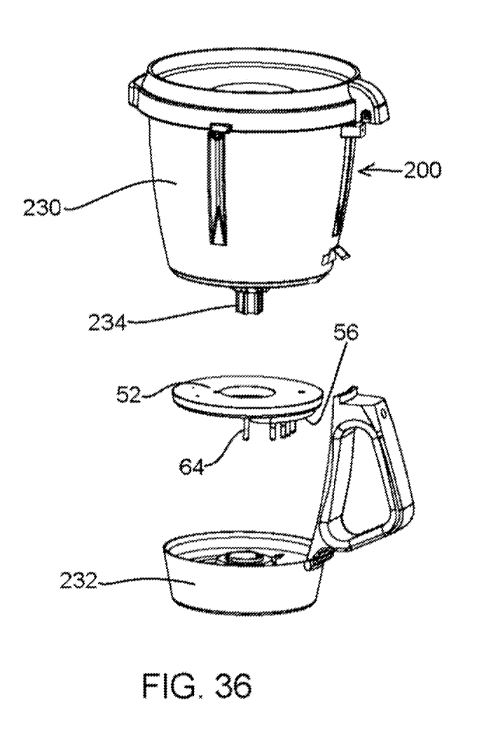

The heating system 50 includes, as seen in FIG. 35, a contact block 56 having three registry bores 58 with each registry bore 58 receiving a respective registry post 60 formed on the stainless steel case 54 when the contact block 56 is secured to the underside of the stainless steel case 54. The contact block 56 includes a heat sensor 62 that extends through the stainless steel case 54 and is operable disposed relative to the disc heating element 52 to sense heat characteristics of the disc heating element. As seen in FIG. 36, the disc heating element 52, the stainless steel case 54, and the contact block 56 are assembled together with the stainless steel case 54 intermediate the contact block 56 and the disc heating element 52. The vessel 200 is configured to secure the assembly of the disc heating element 52, the stainless steel case 54, and the contact block 56 to a portion of the vessel 200 that is spaced from, and sealed against fluid penetration from, a food item retaining portion of the vessel. As seen in FIGS. 34 and 36, the vessel 200 includes a food item retaining portion 230 and a socket portion 232 that is spaced from, and sealed against fluid penetration from, the food item retaining portion 230 of the vessel. A take-off spindle 234 is rotatably mounted on the food item retaining portion 230 and extends through the coincident central openings of the stainless steel case 54 and the disc heating element 52. The take-off spindle 234 serves as a mounting post for the blade component 502 to rotatably drive the blade component within the food item retaining portion 230 and is configured to be operatively coupled to the drive spindle 508 for driving rotation of the blade component 502 via the drive motor 504.

The assembly of the disc heating element 52, the stainless steel case 54, and the contact block 56 is secured via, for example, welding, to the bottom surface of the food item retaining portion 230 of the vessel 200 and a pair of contact prongs 64 of the contact block 56 extend downwardly into compatibly configured receptacles (not shown) in the socket portion 232 of the vessel 200. A pair of bias contact strips each operatively connected to a respective one of the contact prongs 64 extend through the stainless steel case 54 into contact with the underside of the disc heating element 52. The contact block 56 is thus able to be electrically coupled with a suitable power source in the platform 302 such that an electrical current flows via the contact block 56 to the disc heating element 52, whereupon a relatively high resistance characteristic of the material of the disc heating element 52 causes the disc heating element to heat up in correspondence with the wattage of the electrical current directed thereto. In this manner, the heating system 50 provides controllable heating to the vessel 200 such that the duration of heating and the intensity of heating of food items retained in the vessel 200 can be controlled. The vessel 200 is thus configured as a stable, high quality retainer for food items with a heating configuration that is reliably connected with a heating source via the simple action of a user placing the vessel 200 on the platform 302.

In operation, a user can prepare an entire meal such as a stew in the food processing and preparation apparatus 100. Additionally, meal ingredients may be combined for further cooking, shape enhancement or both in the food processing and preparation apparatus 100 and then transferred to an oven for baking, broiling or other cooking. The food processing and preparation apparatus 100 may be pre-programmed with recipes or it is contemplated that the control circuitry 432 may be communicated with a computer or directly to the Internet for firmware updates for the food processing and preparation apparatus and for downloading recipes dedicated to the food processing and preparation apparatus. It is further contemplated that predetermined recipes be packaged with premeasured ingredients in a single package for formulating a single meal or ingredient for further cooking. In addition, the food processing and preparation apparatus is compatible with free form operation wherein the user may program different times or operate in a completely laissez-faire manner and apply stirring, heating or cooling at will.

With respect to each food preparation choice chosen by the user, the user may optionally deposit a single amount or multiple amounts of premeasured ingredients into the food chamber 204 of the vessel 200 and thereafter mount the vessel 200 within the cavity 110 between the arms 106, 108. Thereafter, the user may optionally add further ingredients (if premeasured ingredients had previously been deposited) or may add ingredients for the first time in the preparation process via a step that includes resetting the tare weight (i.e., a reset to a zero value) each time an ingredient is added and then adding the next ingredient in accordance with the recipe instructions or the whims of the user. The food processing and preparation apparatus 100 may then be operated to optionally stir the mixture using the blades 502, heat the mixture using the heating system 700, or cool the mixture using the cooling system 600 for predetermined time periods and in a predetermined order as controlled by the control system 400.

It is also contemplated that the control system include an LED display and the LED display may be a touch-sensitive screen for enhanced interactivity between the user and the food processing and preparation apparatus 100. Once the recipe has been completed, the contents of the vessel 200 may be transferred to further cookware for further cooking or, if the meal is fully prepared, it can be served. It should also be noted that the vessel 200, while preferably formed from stainless steel may also be formed from a ceramic material and the food processing and preparation apparatus 100 may be configured to receive either the stainless steel vessel or a ceramic vessel. With the ceramic vessel, the food processing and preparation apparatus 100 may function generally in the manner of a slow cooker wherein the ceramic walls of the vessel act as a steady heat source.

By the above, the present invention provides a convenient, economical and ecologically sound food processing and preparation apparatus for countertop use wherein the present food processing and preparation apparatus provides enhanced versatility and enhanced efficiency over the current known cooking devices.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

1. A food processing and preparation apparatus comprising:
a housing (102) having a footing portion (104) and an arm section (106,108), the arm section including at least two upwardly projecting arms (106,108) spaced from one another and joined to the footing portion (104) at a trunk transition location (116), with the footing portion and the arm section together delimiting a housing cavity (110);
a vessel (200) defining a food chamber (204) and being positionable in the housing cavity (110);
a blade (502) mounted for movement within the food chamber (204) of the vessel (200);
a blade movement system (500) including a motor (504) mounted within the housing (102) and an intermediary element (508) for transferring motive power from the motor (504) to the blade (502) to thereby effect movement of the blade within the food chamber (204) of the vessel (200);
a heating system (50, 700), the heating system being selectively disposable in contact with at least one of the vessel (200) or contents in the vessel when the vessel is positioned within the housing cavity (110) and the heating system (50, 700) being operable to selectively resist a decrease of the temperature of contents that have been deposited in the vessel (200); and
a control system (400) defining a user interface and including controls for use in operating the apparatus, the controls being in operational communication with the blade movement system (500) and the heating system (50, 700).

2. The food processing and preparation apparatus according to of claim 1 and further comprising a weighing system (800) for selective weighing of a vessel (200) positioned within the housing
cavity (110) and any contents of the vessel and the control system (400) being in operational communication with the blade movement system (500), the heating system (50, 700), and the weighing system (800), wherein the weighing system (800 may include at least two support members (804) for the housing (102), the support members being displaceable from an initial position under the weight of the housing (102), the vessel (200), and the vessel contents, the weighing system (800) further including at least one strain gauge (820) mounted to a first one of the two support members (804) to measure a strain proportional to a displacement of the first support member (804) and the strain gauge (820) being in operational communication with the control system.

3. The food processing and preparation apparatus of claim 1 further comprising a cooling system (600), the cooling system being selectively disposable in contact with at least one of the vessel (200) or contents in the vessel when the vessel is positioned within the housing cavity (110) the cooling system (600) being operable to selectively resist an increase in the temperature of contents that have been deposited in the vessel (200) and the control system (400) being in operational communication with the blade movement system (400), the heating system (50, 700), and the cooling system (600), wherein the cooling system may include a Peltier element and a heat sink (602) in operational communication therewith, wherein the heat sink (602) may be movable into and out of contact with a vessel (200) positioned within the housing cavity (110).

4. The food processing and preparation apparatus of claim 3 wherein the cooling system (600) includes a wick (612) for absorbing condensate from the walls (202) of a vessel (200) positioned within the housing cavity (110) and being cooled by the cooling system (600), wherein the cooling system may further include a
fan (606) for removing hot air from an area adjacent a vessel (200) disposed within the housing cavity (110), with the fan (606) defining an air flow path, and the wick (612) being disposed within the air flow path for evaporative removal of condensate from the wick (612).

5. The food processing and preparation apparatus of claim 1 further comprising a juicer system (900), the juicer system having an upper housing (910) mounted to a lower housing (906) and a strainer and grinder element (908) securable between the upper and lower housings in a position for engagement by a rotary motion device (902) for rotary motion of the strainer and grinder element (908), and the control system (400) being in operational communication with the blade movement system (500), the heating system (50, 700), and the juicer system (900), wherein the upper housing (910) of the juicer system (900) may include an access opening (914) relative to which a plunger (912) can be moved in extension and retraction movements to contact and displace foodstuffs in the strainer and grinder element (908).

6. The food processing and preparation apparatus of claim 1 further comprising a steamer system (950), the steamer system having a first level food container (952) having a plurality of vents (968) and a second level food container (954) nestable with the first level food container (962) and having formed with a plurality of vents (962), and the control system (400) being in operational communication with the blade movement system (500), the heating system (50, 700), and the steamer system (950), wherein the second level food container (954) may include a base in which the plurality of vents (962) are formed and a top (956) having a second plurality of vents (958) such that steam directed from the vessel (200) into the first level food container (952) may pass through the vents (962) in the base of the second level food container (954), contact the contents of the second level food container for a steaming operation, and thereafter spent or exhausted steam may pass outwardly through the second plurality of vents (958) in the top of the second level food container (954).

7. The food processing and preparation apparatus of claim 1 further comprising a spatula (980), the spatula having a spatula blade (984) having a contoured edge compatibly configured with the walls (202) of the vessel (200), wherein the spatula ((980) may further include a generally elongate handle portion (982) and the blade (984) may be formed from rubber or other resilient material.

8. The food processing and preparation apparatus of claim 2 further comprising a cooling system (600), the cooling system being selectively disposable in contact with at least one of the vessel (200) or contents in the vessel when the vessel is positioned within the housing cavity (110) the cooling system (600) being operable to selectively resist an increase in the temperature of contents that have been deposited in the vessel (200) and the control system (400) being in operational communication with the blade movement system (400), the heating system (50, 700), and the cooling system (600), wherein the cooling system may include a Peltier element and a heat sink (602) in operational communication therewith, wherein the heat sink (602) may be movable into and out of contact with a vessel (200) positioned within the housing cavity (110).

9. The food processing and preparation apparatus of claim 8 wherein the cooling system (600) includes a wick (612) for absorbing condensate from the walls (202) of a vessel (200) positioned within the housing cavity (110) and being cooled by the cooling system (600), wherein the cooling system may further include a
fan (606) for removing hot air from an area adjacent a vessel (200) disposed within the housing cavity (110), with the fan (606) defining an air flow path, and the wick (612) being disposed within the air flow path for evaporative removal of condensate from the wick (612).

10. The food processing and preparation apparatus of claim 2 further comprising a juicer system (900), the juicer system having an upper housing (910) mounted to a lower housing (906) and a strainer and grinder element (908) securable between the upper and lower housings in a position for engagement by a rotary motion device (902) for rotary motion of the strainer and grinder element (908), and the control system (400) being in operational communication with the blade movement system (500), the heating system (50, 700), and the juicer system (900), wherein the upper housing (910) of the juicer system (900) may include an access opening (914) relative to which a plunger (912) can be moved in extension and retraction movements to contact and displace foodstuffs in the strainer and grinder element (908).

11. The food processing and preparation apparatus of claim 3 further comprising a juicer system (900), the juicer system having an upper housing (910) mounted to a lower housing (906) and a strainer and grinder element (908) securable between the upper and lower housings in a position for engagement by a rotary motion device (902) for rotary motion of the strainer and grinder element (908), and the control system (400) being in operational communication with the blade movement system (500), the heating system (50, 700), and the juicer system (900), wherein the upper housing (910) of the juicer system (900) may include an access opening (914) relative to which a plunger (912) can be moved in extension and retraction movements to contact and displace foodstuffs in the strainer and grinder element (908).

12. The food processing and preparation apparatus of claim 4 further comprising a juicer system (900), the juicer system having an upper housing (910) mounted to a lower housing (906) and a strainer and grinder element (908) securable between the upper and lower housings in a position for engagement by a rotary motion device (902) for rotary motion of the strainer and grinder element (908), and the control system (400) being in operational communication with the blade movement system (500), the heating system (50, 700), and the juicer system (900), wherein the upper housing (910) of the juicer system (900) may include an access opening (914) relative to which a plunger (912) can be moved in extension and retraction movements to contact and displace foodstuffs in the strainer and grinder element (908).

13. The food processing and preparation apparatus of claim 2 further comprising a steamer system (950), the steamer system having a first level food container (952) having a plurality of vents (968) and a second level food container (954) nestable with the first level food container (962) and having formed with a plurality of vents (962), and the control system (400) being in operational communication with the blade movement system (500), the heating system (50, 700), and the steamer system (950), wherein the second level food container (954) may include a base in which the plurality of vents (962) are formed and a top (956) having a second plurality of vents (958) such that steam directed from the vessel (200) into the first level food container (952) may pass through the vents (962) in the base of the second level food container (954), contact the contents of the second level food container for a steaming operation, and thereafter spent or exhausted steam may pass outwardly through the second plurality of vents (958) in the top of the second level food container (954).

14. The food processing and preparation apparatus of claim 3 further comprising a steamer system (950), the steamer system having a first level food container (952) having a plurality of vents (968) and a second level food container (954) nestable with the first level food container (962) and having formed with a plurality of vents (962), and the control system (400) being in operational communication with the blade movement system (500), the heating system (50, 700), and the steamer system (950), wherein the second level food container (954) may include a base in which the plurality of vents (962) are formed and a top (956) having a second plurality of vents (958) such that steam directed from the vessel (200) into the first level food container (952) may pass through the vents (962) in the base of the second level food container (954), contact the contents of the second level food container for a steaming operation, and thereafter spent or exhausted steam may pass outwardly through the second plurality of vents (958) in the top of the second level food container (954).

15. The food processing and preparation apparatus of claim 4 further comprising a steamer system (950), the steamer system having a first level food container (952) having a plurality of vents (968) and a second level food container (954) nestable with the first level food container (962) and having formed with a plurality of vents (962), and the control system (400) being in operational communication with the blade movement system (500), the heating system (50, 700), and the steamer system (950), wherein the second level food container (954) may include a base in which the plurality of vents (962) are formed and a top (956) having a second plurality of vents (958) such that steam directed from the vessel (200) into the first level food container (952) may pass through the vents (962) in the base of the second level food container (954), contact the contents of the second level food container for a steaming operation, and thereafter spent or exhausted steam may pass outwardly through the second plurality of vents (958) in the top of the second level food container (954).

16. The food processing and preparation apparatus of claim 5 further comprising a steamer system (950), the steamer system having a first level food container (952) having a plurality of vents (968) and a second level food container (954) nestable with the first level food container (962) and having formed with a plurality of vents (962), and the control system (400) being in operational communication with the blade movement system (500), the heating system (50, 700), and the steamer system (950), wherein the second level food container (954) may include a base in which the plurality of vents (962) are formed and a top (956) having a second plurality of vents (958) such that steam directed from the vessel (200) into the first level food container (952) may pass through the vents (962) in the base of the second level food container (954), contact the contents of the second level food container for a steaming operation, and thereafter spent or exhausted steam may pass outwardly through the second plurality of vents (958) in the top of the second level food container (954).

17. The food processing and preparation apparatus of claim 2 further comprising a spatula (980), the spatula having a spatula blade (984) having a contoured edge compatibly configured with the walls (202) of the vessel (200), wherein the spatula ((980) may further include a generally elongate handle portion (982) and the blade (984) may be formed from rubber or other resilient material.

18. The food processing and preparation apparatus of claim 3 further comprising a spatula (980), the spatula having a spatula blade (984) having a contoured edge compatibly configured with the walls (202) of the vessel (200), wherein the spatula ((980) may further include a generally elongate handle portion (982) and the blade (984) may be formed from rubber or other resilient material.

19. The food processing and preparation apparatus of claim 4 further comprising a spatula (980), the spatula having a spatula blade (984) having a contoured edge compatibly configured with the walls (202) of the vessel (200), wherein the spatula ((980) may further include a generally elongate handle portion (982) and the blade (984) may be formed from rubber or other resilient material.

20. The food processing and preparation apparatus of claim 5 further comprising a spatula (980), the spatula having a spatula blade (984) having a contoured edge compatibly configured with the walls (202) of the vessel (200), wherein the spatula ((980) may further include a generally elongate handle portion (982) and the blade (984) may be formed from rubber or other resilient material.
